(19) United States
(12) Patent Application Publication
(10) Pub. No.: US 2024/0403368 A1
(43) Pub. Date: Dec. 5, 2024

(54) SYSTEM AND METHOD OF ASSOCIATING DIGITAL MEDIA WITH COLLECTIBLE-PROTECTIVE APPARATUS

(71) Applicant: Rare Edition LLC, Arlington, VA (US)

(72) Inventors: Joshua Allen Cosio Llado, Arlington, VA (US); Jason Peter Burrows, Arlington, VA (US)

(73) Assignee: Rare Edition LLC, Arlington, VA (US)

(21) Appl. No.: 18/677,535

(22) Filed: May 29, 2024

Related U.S. Application Data
(60) Provisional application No. 63/505,033, filed on May 30, 2023.

(51) Int. Cl. G06F 16/904; A63F 1/06; G06F 21/32

(52) U.S. Cl. CPC G06F 16/904; A63F 1/062; G06F 21/32

(57) ABSTRACT

A method comprising: receiving, from a first user, account identification information associated with first user, authenticating, by collectible object management system, first user based on account identification information associated with first user, receiving, from first user, a first collectible protective apparatus identifier and a first collectible object identifier, the first collectible protective apparatus identifier being associated with a first collectible protective apparatus, the first collectible object identifier being associated with a first collectible object protected by the first collectible protective apparatus, authenticating, by the collectible object management system, the first collectible protective apparatus identifier and the first collectible object identifier, providing, by the collectible object management system, a user interface associated with the first collectible object, receiving a request to upload first digital media to the collectible management system, the digital media being associated with the first collectible object, and storing the first digital media to the collectible management system.

### CROSS-REFERENCE TO RELATED APPLICATIONS

The present application claims the benefit of U.S. Provisional Patent Application No. 63/505,033 filed May 30, 2023, entitled “Communication Device of a Collectible-Protective Apparatus,” which is incorporated by reference herein.

### FIELD OF THE INVENTIONS

Embodiments described herein generally relate to a system and method of associating digital media with a collectible-protective apparatus and collectible object protected therewithin. The collectible may be one or more trading cards, game cards, sports cards, collectible cards, autographs, letters, coins, stamps, and the like.

### BACKGROUND

A collectible-protective apparatus is any apparatus (e.g., case, frame, or the like) configured and/or designed to protect a collectible stored within the collectible-protective apparatus. In one example, the collectible-protective apparatus protects a collectible card stored within the apparatus. Collectible cards such as trading cards, sports cards, game cards, or collectible cards may include a card depicting information and/or an image of a person, place, thing, and/or concept. Cards as described herein typically comprise paper, cardboard, and/or similar materials. A card as discussed herein may be related to sports (e.g., baseball cards), a game, or the like. In some examples, a card may depict and/or describe non-fiction people, nonfictional or fictional animals, fictional people or animals, spells, nonfictional or fictional places, actions, nonfictional or fictional items, and/or the like.

In some embodiments, the collectible-protective apparatus protectors other collectibles such as stamps, coins, autographs, paper, stamps, autographed sports jerseys, pamphlets, autographed footwear, plush toys, toy building blocks such as models made of LEGO bricks, and the like.

A collectible-protective apparatus may protect valuable collectible cards (e.g., trading cards, sports cards, game cards, and/or the like). The collectible-protective apparatus discussed herein is described as being configured to hold a card (e.g., the collectible-protective apparatus may be a card protector). However, it will be appreciated that similar collectible-protective apparatuses (e.g., of many different sizes) may protect other items such as stamps, autographs, paper, coins, pamphlets, and the like. It will be appreciated that any valuable item (or two or more valuable items) may be stored within the collectible-protective apparatus described herein. Some embodiments allow for a UV-resistant, tamper-resistant case to protect the enclosed item from damage that may affect the value of the enclosed item.

### SUMMARY

An example method comprising, receiving, from a first user, account identification information associated with the first user, authenticating, by a collectible object management system, the first user based on the received account identification information associated with the first user, receiving, from the first user, a first collectible protective apparatus identifier and a first collectible object identifier, the first collectible protective apparatus identifier being associated with a first collectible protective apparatus, the first collectible object identifier being associated with a first collectible object protected by the first collectible protective apparatus, authenticating, by the collectible object management system, the first collectible protective apparatus identifier and the first collectible object identifier, providing, by the collectible object management system, a user interface associated with the first collectible object, receiving a request to upload a first digital media to the collectible management system, the digital media being associated with the first collectible object, and storing the first digital media to the collectible management system.

The first collectible object is stored within the first collectible protective apparatus. In some embodiments, the first collectible protective apparatus comprises, a first panel, the first panel including a front side and a back side, the first panel including at least a transparent portion, and a rear panel coupled to the first panel, the rear panel including a front side and a back side, the front side of the rear panel including at least four supporting members, each of the at least four supporting members including a flat edge to enable positioning of the collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object.

In one example, the collectible object identifier is located on a grading certificate. In one example, the grading certificate is located in an upper portion of the collectible protective apparatus. In some embodiments, the first collectible protective apparatus identifier is located on a bottom edge of the first collectible protective apparatus. In various embodiments, the first collectible protective apparatus identifier is a numerical identifier, in another example, the first collectible protective apparatus identifier is a bar code.

In some embodiments, the collectible protective apparatus further comprises, a security feature between the first panel and the second panel, the security feature including at least one of an NFC chip and an RFID chip, the security feature being beneath a mask such that the security feature is not visible from the front of the first panel, wherein the NFC chip or the RFID chip provide the first collectible protective apparatus identifier.

In some embodiments, the method of further comprising, receiving, from a second user, account identification information associated with the second user, authenticating, by a collectible object management system, the second user based on the received account identification information associated with the second user, receiving, from the second user, a second collectible protective apparatus identifier and a second collectible object identifier, the second collectible protective apparatus identifier being associated with a second collectible protective apparatus, the first collectible object identifier being associated with a first collectible object protected by the first collectible protective apparatus, providing, by the collectible object management system, a user interface associated with the second collectible object, receiving a request to upload a second digital media to the collectible management system, the digital media being associated with the second collectible object, and storing the second digital media to the collectible management system.

In one example, the method further comprising, receiving, from a third user, a request to view the first digital media associated with the first collectible object and providing to the third user access to view the first digital media, the third user not having access to change the first digital media without the first collectible protective apparatus identifier and the first collectible object identifier.

An example system comprising, a first collectible protective apparatus, the first collectible protective apparatus including a first collectible object identifier, a first collectible object, the first collectible object being stored within the first collectible protective apparatus, the first collectible object including a first collectible protective apparatus identifier, a collectible object management system, at least one processor, a memory including instructions to configure the at least one processor to instruct the collectible object management system perform a method, the method comprising, receiving the first collectible protective apparatus identifier and the first collectible object identifier being associated with a first collectible object, providing a user interface associated with the first collectible object, receiving a request to upload a first digital media to the collectible management system, the digital media being associated with the first collectible object, and storing the first digital media to the collectible management system.

In one example the collectible object is stored within the collectible protective apparatus. In some embodiments, the first collectible protective apparatus further includes a first panel, the first panel including a front side and a back side, the first panel including at least a transparent portion, and a rear panel coupled to the first panel, the rear panel including a front side and a back side, the front side of the rear panel including at least four supporting members, each of the at least four supporting members including a flat edge to enable positioning of the collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object. In some embodiments, the collectible object identifier is located on a grading certificate. In one example, the grading certificate is located in an upper portion of the collectible protective apparatus. In various embodiments, the first collectible protective apparatus identifier is located on a bottom edge of the first collectible protective apparatus.

In one example, the collectible protective apparatus further comprises: a security feature between the first panel and the second panel, the security feature including at least one of an NFC chip and an RFID chip, the security feature being beneath a mask such that the security feature is not visible from the front of the first panel, wherein the NFC chip or the RFID chip provide the first collectible protective apparatus identifier. In one example, the method further comprise: receiving, from a second user, account identification information associated with the second user, authenticating, by a collectible object management system, the second user based on the received account identification information associated with the second user, receiving, from the second user, a second collectible protective apparatus identifier and a second collectible object identifier, the second collectible protective apparatus identifier being associated with a second collectible protective apparatus, the first collectible object identifier being associated with a first collectible object protected by the first collectible protective apparatus, providing, by the collectible object management system, a user interface associated with the second collectible object, receiving a request to upload a second digital media to the collectible management system, the digital media being associated with the second collectible object, and storing the second digital media to the collectible management system.

In one example, the collectible object management system is further configured to receive, from a third user, a request to view the first digital media associated with the first collectible object and provide to the third user access to view the first digital media, the third user not having access to change the first digital media without the first collectible protective apparatus identifier and the first collectible object identifier.

An example non-transitory computer readable medium comprising instructions executable by one or more processors to perform a method, the method comprising, receiving, from a first user, account identification information associated with the first user, authenticating, by a collectible object management system, the first user based on the received account identification information associated with the first user, receiving, from the first user, a first collectible protective apparatus identifier and a first collectible object identifier, the first collectible protective apparatus identifier being associated with a first collectible protective apparatus, the first collectible object identifier being associated with a first collectible object protected by the first collectible protective apparatus, authenticating, by the collectible object management system, the first collectible protective apparatus identifier and the first collectible object identifier, providing, by the collectible object management system, a user interface associated with the first collectible object, receiving a request to upload a first digital media to the collectible management system, the digital media being associated with the first collectible object, and storing the first digital media to the collectible management system.

### BRIEF DESCRIPTION OF THE DRAWINGS

FIG. 1A depicts a frontal view of a collectible-protective apparatus in some embodiments.

FIG. 1B depicts a perspective view of a collectible-protective apparatus in some embodiments.

FIG. 1C depicts another perspective view of a collectible-protective apparatus in some embodiments.

FIG. 1D depicts another frontal view of a collectible-protective apparatus in some embodiments.

FIG. 2 depicts an example environment capable allowing users to associate digital media with a collectible-protective apparatus and collectible object protected therewithin according to some embodiments.

FIG. 3 depicts a block diagram of an example collectible object management system according to some embodiments.

FIG. 4 depicts a method of storing a digital media with a collectible-protective apparatus and a particular copy of a collectible object stored therewithin according to some embodiments.

FIG. 5 depicts a method of accessing a digital media with a collectible-protective apparatus and a particular copy of a collectible object stored therewithin according to some embodiments.

FIG. 6A depicts an example user interface provided by the collectible object management system that allows users to access information regarding their collectible objects according to some embodiments.

FIG. 6B depicts another example user interface provided by the collectible object management system that allows users to access information regarding their collectible objects according to some embodiments.

FIG. 7A depicts an example user interface provided by the collectible object management system that allows users to provide identification information associated with the collectible-protective apparatus and the collectible object stored therewithin according to some embodiments.

FIG. 7B depicts another example user interface provided by the collectible object management system that allows users to provide identification information associated with the collectible-protective apparatus and the collectible object stored therewithin according to some embodiments.

FIG. 8A depicts a front view of an example collectible-protective apparatus in some embodiments.

FIG. 8B depicts a back view of an example collectible-protective apparatus in some embodiments.

FIG. 9 depicts a bottom view of the collectible-protective apparatus according to some embodiments.

FIG. 10 depicts an example user interface associated with a particular collectible object in the collectible-protective according to some embodiments.

FIG. 11 depicts an example user interface providing according to some embodiments.

FIG. 12 depicts an example user interface according to some embodiments.

FIG. 13 depicts a provided user interface according to some embodiments.

FIG. 14 depicts an example user interface with a digital image of an uploaded digital according to some embodiments.

FIG. 15 depicts an example verification interface provided by the collectible object management system according to some embodiments.

FIG. 16 depicts an example acknowledgement interface provided by the collectible object management system according to some embodiments.

FIG. 17 depicts an example grading report interface in some embodiments.

FIG. 18 depicts another example grading report interface in some embodiments.

FIG. 19 depicts an example collectible card interface containing information regarding a card in some embodiments.

FIG. 20 depicts an example marketplace interface in some embodiments.

FIG. 21A depicts one example side of a back panel that makes up the protective apparatus in some embodiments.

FIG. 21B depicts another example side of the back panel, which makes up the protective apparatus in some embodiments.

FIG. 22A depicts one example side of a front panel that makes up the protective apparatus in some embodiments.

FIG. 22B depicts another example side of the front panel, which makes up the protective apparatus in some embodiments.

FIG. 23 depicts a perspective view of a bumper in some embodiments.

FIG. 24A depicts a front view of a protective apparatus with a bumper in some embodiments.

FIG. 24B depicts one perspective view of a protective apparatus with a bumper in some embodiments.

FIG. 24C depicts another perspective view of a protective apparatus with a bumper in some embodiments.

FIG. 25A depicts an example front view and cross-sections of the back panel in some embodiments.

FIG. 25B depicts an example front view and cross-sections of the back panel with measurements.

FIG. 25C depicts an example logo in some embodiments.

FIG. 26A depicts an example back view and cross-sections of the protective apparatus in some embodiments.

FIG. 26B depicts an example energy director for ultrasonic welding in some embodiments.

FIG. 27 depicts an example cross-section of a back panel and a front panel of the protective apparatus in some embodiments.

FIG. 28 depicts a collectible-protective apparatus with a stamp stored therewithin according to some embodiments.

FIG. 29 depicts a collectible-protective apparatus with a coin stored therewithin according to some embodiments.

FIG. 30 is an example of a digital device in some embodiments.

### DETAILED DESCRIPTION

In various embodiments, a user may upload digital media to a collectible object management system. The digital media may be associated with a collectible-protective apparatus and/or collectible object stored therewithin. The digital media may be or include image(s), video(s), virtual reality file(s), augmented reality file(s), and/or the like. The digital media may be stored in the collectible object management system and accessed by one or more users on any number of remote digital devices.

The collectible-protective apparatus may include an active or passive system to allow a user to access, via a mobile computing device or a desktop computer, to a user interface provided by the collectible object management system. In one example of an active system, the collectible-protective apparatus may include a near field communication (NFC) chip and/or a radio frequency identification (RFID) chip. These features may allow and/or facilitate access to a user interface provided by the collectible object management system. The user may interact with the user interface provided by the collectible object management system to access information regarding one or more collectible objects and/or interact with the stored digital media.

The collectible object management system may provide a user interface to allow the user to add or remove one or more digital media associated with the particular collectible object and/or the collectible-protective apparatus. The digital media may be accessible by providing, to the collectible object management system, identification information (e.g., one or more identifiers) associated with the collectible-protective apparatus and/or the collectible object stored therewithin.

In some embodiments, the user may designate who can view the digital media. The user, for example, may require viewers to input identification information before viewing the digital media on the collectible object management system. The identification information may be one or more of a password, passcode, biometric identification, and the like. In one example, the user may choose to make the digital media viewable without requiring identification information (e.g., allowing all or some of the digital media to be accessible or viewable to the public or anyone with access to the collectible object management system).

A user may associate one or more digital media with a particular collectible object stored within a collectible-protective apparatus. People with different copies of the same collectible object (e.g., different copies of the same baseball card) may associate a different digital media with their respective copies of the same collectible object. In some embodiments, multiple copies of the same collectible object may be associated with the same digital media.

In various embodiments, the user interface may provide a collectible object grading interface which includes a score or category of the collectible object based on properties (e.g., physical properties and/or quality of the collectible based on value and/or other attributes) of the collectible object. The user interface may include a marketplace interface that provides an online platform to connect users to sell or buy graded or ungraded collectible cards (e.g., including collectible cards protected by a protective apparatus).

In some embodiments, the collectible object management system associates digital media with one or more collectible objects that are not stored within a collectible-protective apparatus.

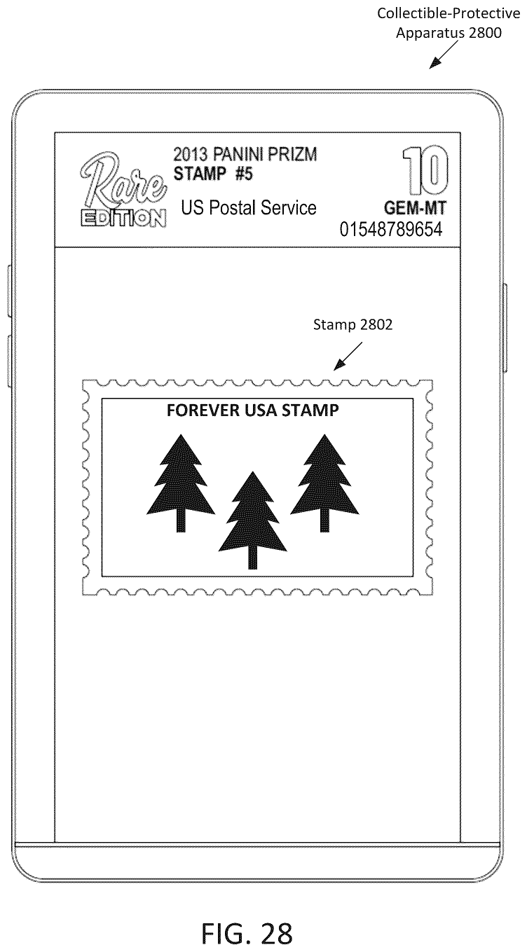

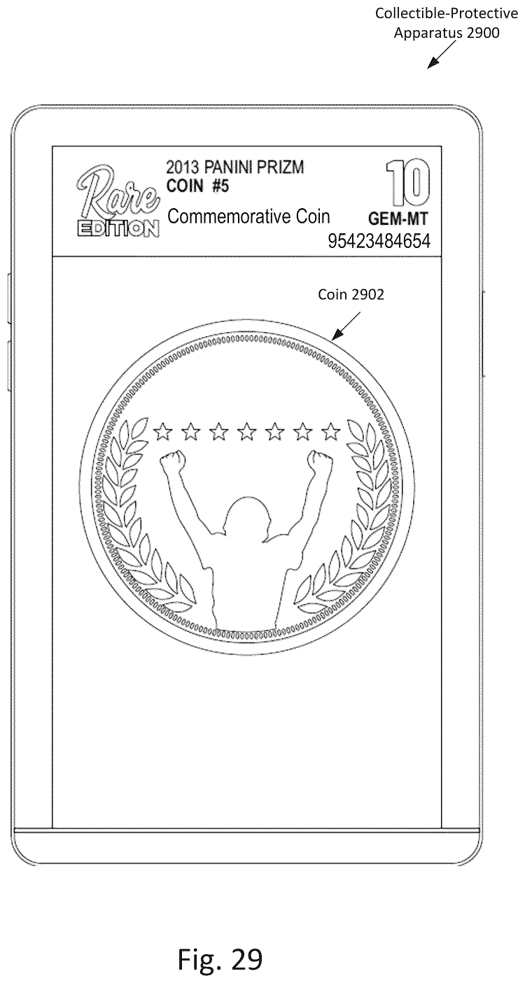

A collectible-protective apparatus may protect valuable collectible objects such as cards (e.g., trading cards, sports cards, game cards, and/or the like). The collectible-protective apparatus discussed herein is described as being configured to hold a card (e.g., the protective apparatus may be a card protector). However, it will be appreciated that similar collectible-protective apparatus (e.g., of many different sizes) may protect other items such as stamps, autographs, paper, coins, pamphlets, and the like. In one example, a collectible-protective apparatus 2800 of FIG. 28 stores a stamp 2802 therewithin. In another example, a collectible-protective apparatus 2900 of FIG. 29 stores a coin 2902 therewithin. It will be appreciated that any valuable item (or two or more valuable items) may be stored within the collectible-protective apparatus described herein. Some embodiments allow for a UV-resistant, tamper-resistant case to protect the enclosed item from damage that may affect the value of the enclosed item.

In some embodiments, the collectible-protective apparatus (e.g., card case) also includes a removable bumper surrounding the edges of the collectible-protective apparatus. The bumper may protect the card encased within the protective apparatus as well as protect the collectible-protective apparatus itself.

While a bumper is shown surrounding the edges of the collectible-protective apparatus, it will be appreciated that the bumper may enclose all or a back portion of the collectible-protective apparatus. In some embodiments, the bumper may be similar to a smartphone case that encloses the edges of a smartphone or encloses the edges and the back of the smartphone. In some embodiments, the bumper may protect the back part of the device or a portion of the back part of the collectible-protective apparatus. In one example, the bumper may surround the edges of the protective apparatus as well as a part of the back of the collectible-protective apparatus. In this example, the bumper may include an opening or window to allow parts of the enclosed card or collectible-protective apparatus to be seen from behind (e.g., information on the back of the card and/or protective apparatus may be seen through a hole or window in the back bumper).

It will be appreciated that the bumper may be composed of one or more different materials. The one or more different materials may be resilient. In two examples, the bumper may be composed of silicone or TPU (thermoplastic polyurethane).

The collectible-protective apparatus may protect a valuable and/or collectible card. Such cards may be graded based on their physical condition. A higher grade typically correlates with the card being more desirable and valuable. Properties that may be graded include, for example, damage to the card, bends or breaks in the card, centering of images on the card, sharpness of the corners of the card, gloss on the card, fading of pictures, degradations of card stock quality, and the presence of any imperfections. The collectible-protective apparatus may, in some embodiments, protect the graded card from environmental elements such as dust and water.

The collectible-protective apparatus may protect a graded or valuable card and/or contain an indication of the grading system (or grade). For example, a certificate or indication on the protective apparatus may indicate a grading of the card and one or more overt or covert security features to validate the authenticity of the card and grade. The collectible-protective apparatus may protect a graded card from tampering and protect the authenticity of the graded card.

In some embodiments, the collectible-protective apparatus is rectangular and may have rounded or sharp corners. In various embodiments, the collectible-protective apparatus is square with sharp corners or a squircle, which is a shape intermediate between a square and a circle. In one embodiment, the collectible-protective apparatus is a quadrilateral and may have rounded or sharp corners. The collectible-protective apparatus consists of two or more members that may be coupled to each other (e.g., via interlocking, glue, vibration, laser, or the like). The slabs or portions may be coupled to create a chamber or cavity that may hold or store a card or other collectible. In various embodiments, the top portion and the bottom portion are adhered to one another to create a tamper-resistant seal. It will be appreciated that the collectible-protective apparatus may include any number of parts that are coupled together.

The collectible-protective apparatus may include a mask. The mask may consist of tape or an opaque material coupled to a part of the collectible-protective apparatus. In one example, the mask may surround an inner edge of the top portion of the collectible-protective apparatus. In some embodiments, the mask may cover all or part of the connection between two portions (e.g., two halves) of the collectible-protective apparatus. The mask may also cover a front portion and create the appearance of two windows on the front of the protective apparatus (e.g., a larger window and a smaller window). The front face of the collectible-protective apparatus may include a lower portion window and a more narrow, upper portion window. In some embodiments, the mask may be applied to one side of the top portion of the collectible-protective apparatus using a hot stamping method. It will be appreciated that other printing methods may be utilized to apply the mast to the top portion of the protective apparatus.

In some embodiments, a logo (e.g., “Rare Edition”), a near field communication (NFC) chip, and/or a radio frequency identification (RFID) chip may be placed in the connection between the lower portion window and the upper portion window of the top portion of the collectible-protective apparatus. In various embodiments, the logo, NFC chip and/or RFID chip may be placed in the upper portion window of the collectible-protective apparatus. The bottom portion of the collectible-protective apparatus may include four supporting members (long protrusions) that may support a card within the protective apparatus. The cavity produced by the four supporting members may correspond to the lower portion window of the top portion of the collectible-protective apparatus and may support and protect the card or collectible object.

In some embodiments, each of the portions of the collectible-protective apparatus may be composed of polycarbonate. In one example, a coating may be applied to the portions of the collectible-protective apparatus to make the protective apparatus resistant to ultraviolet (UV) light and/or other types of light that may be harmful to the contained collectible. In various embodiments, a coating may be applied to the portions of the collectible-protective apparatus to make the collectible-protective apparatus scratch resistant and/or bulletproof. In one example, scratch-resistant glass, such as CORNING® GORILLA® glass, may be applied to the surface of the collectible-protective apparatus.

Portions of the collectible-protective apparatus may be coupled together using an ultrasonic welder or laser welding. By coupling the portions together, the collectible-protective apparatus may prevent tampering (i.e., tampering may be obvious due to damage to the collectible-protective apparatus). In some embodiments, when coupled together, the collectible-protective apparatus may be waterproof or water-resistant.

In various embodiments, the removable bumper is a removable silicone bumper. The removable bumper may provide further protection to the card protector by protecting it from impact. The removable bumper may be available in different colors, allowing a user to customize or organize card protectors using different colored bumpers. In various embodiments, the removable bumper is fabricated with other materials such as thermoplastic elastomers (TPE's), latex, or rubber.

The collectible-protective apparatus may include one or more passive devices which allow the collectible-protective apparatus to communicate with an application (e.g., smartphone app) and/or grading system.

An owner of a collectible card may send a request to the collectible object management system to grade their collectible card based on their physical condition. A higher grade typically correlates with the card being more desirable and valuable. The collectible object management system may grade collectible cards using a deep neural network, thereby reducing the occurrence of inconsistent grading, which occurs when collectible cards are graded by humans. In some embodiments, the deep neural network is a convolution neural network (CNN). In one embodiment, the deep neural network is trained using collectible cards graded by a human. In one example, the grading system may provide rankings to collectible cards.

In some embodiments, the collectible object management system may provide an online platform to connect users to sell or buy graded or ungraded collectible cards (e.g., including collectible cards protected by a protective apparatus). The collectible object management system may display a virtual version of a graded card and highlight one or more parts of the graded card. The collectible object management system may provide a search function that allows users to provide one or more search criteria to a marketplace interface. The collectible object management system may provide digital images of one or more collectible cards.

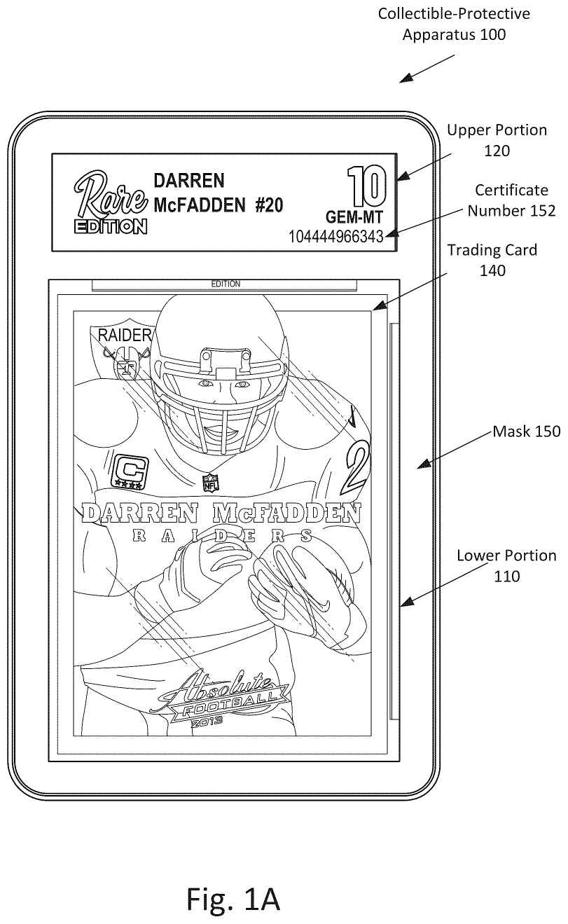

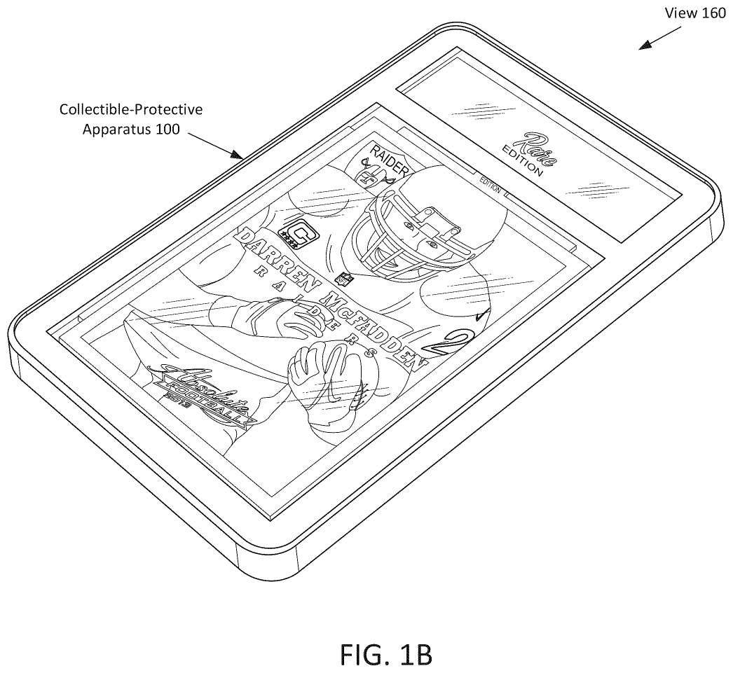

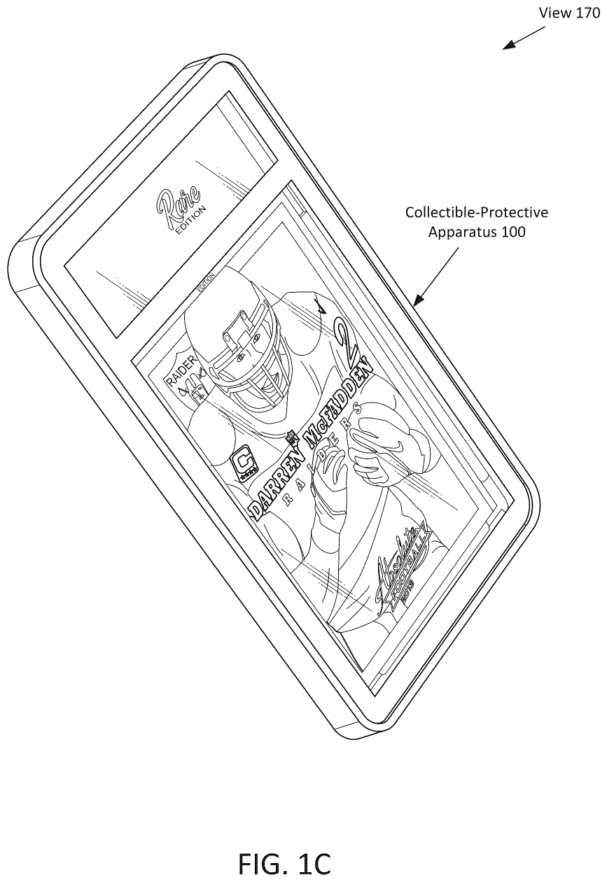

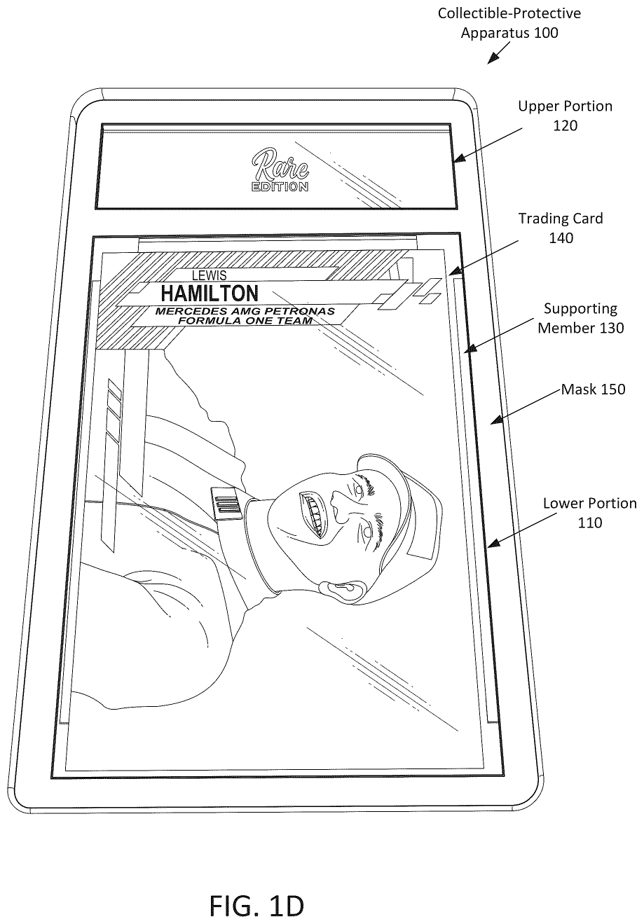

FIG. 1A depicts a perspective view of a collectible-protective apparatus 100 with a bumper in some embodiments. In this example, the collectible-protective apparatus 100 includes a lower portion 110, an upper portion 120, and a mask 150. In the example of FIG. 1A, the collectible-protective apparatus 100 is rectangular and has rounded corners.

The collectible-protective apparatus 100 may include a front panel coupled to a back panel. The front panel and/or the back panel may contain supporting members and protective members (e.g., formed from plastic or any material) configured to keep the front panel and the back panel coupled and to position the collectible object. The front panel and the back panel are further discussed herein.

In various embodiments, the front panel and/or the back panel may be transparent thereby allowing the collectible card to be viewed through the protective apparatus.

The lower portion 110 may be or include a window, holder, cavity, or the like configured to display a collectible object such as a trading card 140. The lower portion 110 may be transparent or include a transparent material (e.g., the lower portion 110 may include a window) to display the collectible object. Behind the transparent window, the collectible-protective apparatus 100 may include a holder, retaining members, and the like for positioning and holding the media (e.g., autograph, logo, or the like) for display through the lower portion 110.

There may be a cavity configured to hold, position, and protect the collectible object behind the transparent window of the lower portion 110.

In some embodiments, the lower portion 110 may have a width of approximately 64.5 millimeters (mm) and a length of approximately 90 mm. The collectible-protective apparatus 100 may include any number of rectangular supportive members to position and reduce movement of the collectible object for consistent display through the lower portion 110.

The upper portion 120 may be a window, holder, cavity, or the like configured to display information such as a logo, grading system, card name, collectible name, autograph, or the like. The upper portion 120 may be transparent (e.g., the upper portion 120 may include a window) as well as a cavity for holding other media (e.g., a card, plastic, photograph, or other media) for protection and display through the upper portion 120. For example, the upper portion 120 may include a transparent window. Behind the transparent window, the collectible-protective apparatus 100 may include a holder, retaining members, and the like for positioning and holding the media (e.g., autograph, logo, or the like) for display. Alternatively, the upper portion 120 may include a media coupled to the upper portion 120. The coupled media may be plastic, metallic, paper, or the like. The coupled media may, in some embodiments, display information or be blank.

In some embodiments, a grading certificate is coupled to the upper portion 120 of the collectible-protective apparatus 100 includes identification information of the collectible object held within the collectible-protective apparatus 100, a logo, a numerical or alphabetical representation of the grade of the collectible object, and a certificate number 152.

In some embodiments, the certificate number 152 may be utilized to uniquely identify a particular copy of a collectible card that has been graded and/or authenticated by a collectible object management system. In one example, certificate number 152 may be used to identify unique collectible objects, as opposed to unique copies of a particular collectible object. In some embodiments, the grading certificate is located in a cavity located in the upper portion 120 of the collectible-protective apparatus 100. In other embodiments, the grading certificate is displayed on or within the collectible-protective apparatus 100 at any location. As discussed herein, the grading certificate or information of the grading certificate may be displayed on or within the collectible-protective apparatus 100.

A view 160 of FIG. 1B depicts a perspective view of the collectible-protective apparatus 100 from a different angle.

A view 170 of FIG. 1C depicts another perspective view of the collectible-protective apparatus 100 from a different angle.

In some embodiments, the collectible-protective apparatus 100 may include one or more supporting members positioned along the perimeter or boundaries of the lower portion 110 or the upper portion 120. The supporting members may assist in strengthening the collectible-protective apparatus 100 and/or position the collectible object or information contained within the collectible-protective apparatus 100.

In one embodiment, the mask 150 may consist of tape or an opaque material coupled to a back face of the top portion of the collectible-protective apparatus 100. The mask 150 may cover all or part of the connection between two portions (e.g., two halves) of the protective apparatus.

In some embodiments, the upper portion 120 and the lower portion 110 may be part of a single rectangular window. The mask 150 may extend through the single rectangular window to create the appearance of two windows. In some embodiments, the mask 150 may be applied to one side of the top portion of the protective apparatus using a hot stamping method. It will be appreciated that other printing methods may be utilized to apply the mast to the top portion of the protective apparatus.

In some embodiments, a logo, an NFC chip, or an RFID chip may be contained within or upon the collectible-protective apparatus 100. In one example, the logo, NFC chip, and/or RFID chip may be positioned or coupled to the collectible-protective apparatus 100 between the upper portion 120 and the lower portion 110. In some embodiments, there may be a logo, NFC chip, and/or RFID chip anywhere between or on the top or bottom portions. In various embodiments, the NFC chip and/or the RFID chip is positioned in the upper portion 120 of the collectible-protective apparatus 100.

In one embodiment, the user may interact with the radio frequency identification device (RFID) tag or near field communication (NFC) chip using a mobile computing device with a software application installed thereon. The user may bring a mobile computing device, such as a smartphone, in proximity to the collectible-protective apparatus 100. When a user interacts with the RFID tag or NFC chip, the user may be provided with an address or be directed to navigate to a webpage containing information regarding the card and/or rating system. FIG. 1D depicts another frontal view of the collectible-protective apparatus 100. In some embodiments, when a user interacts with the RFID tag or NFC chip, the user may be provided with an address or be directed to navigate to a collectible object management system to store, access, remove, and/or view digital media (e.g., associated with the collectible or the collectible-protective apparatus 100).

In some embodiments, the webpage or card information may include digital images or videos of the collectible object within the collectible-protective apparatus 100 (associated with the collectible object). In one example of a collectible card, the webpage or card information may include details of the physical condition of the collectible card and grading information such as overall features that impact value (e.g., rareness of the card, features that were used to grade the card), quality of the card, and/or any damage that may impact grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

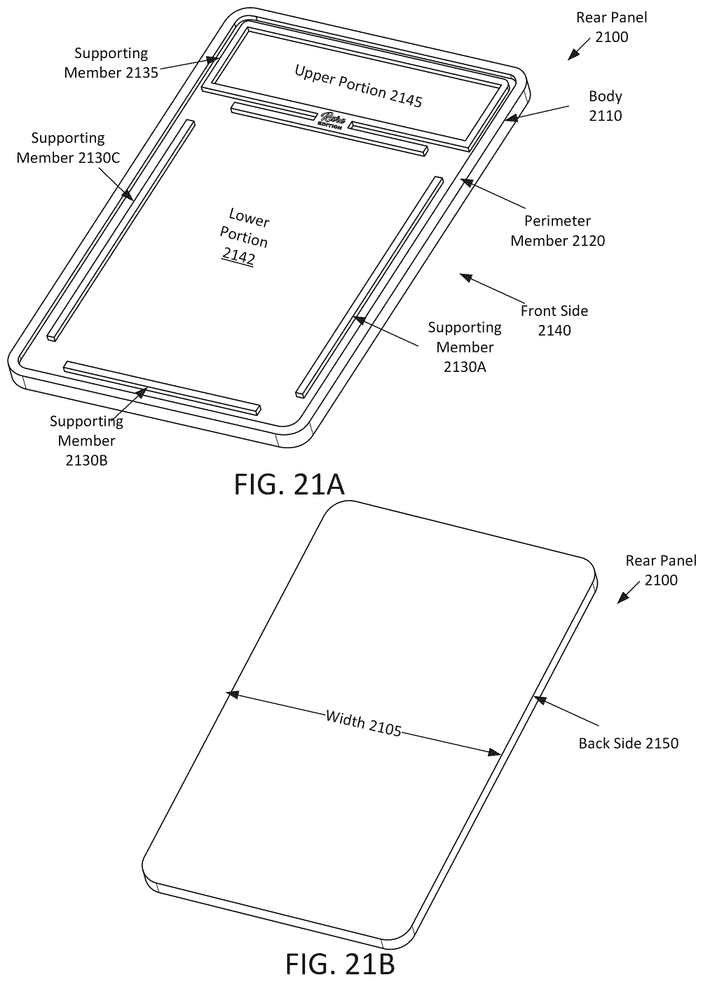

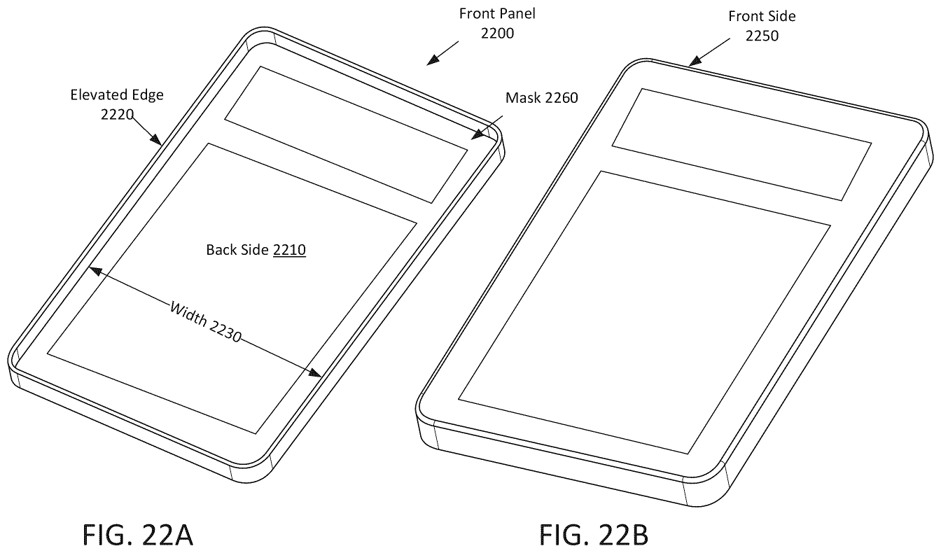

In some embodiments, the collectible-protective apparatus 100 comprises of two or more panels coupled together to create one or more cavities that may hold or store a card or other collectible. The collectible-protective apparatus 100 may comprise the rear panel 2100 (see FIGS. 21A and 21B) and the front panel 2200 (see FIGS. 22A and 22B).

In various embodiments, the front panel and the rear panel are adhered to one another to create a tamper-resistant seal as further discussed herein.

Either or both panels may be comprised of polycarbonate, metal, alloy, or any material. In various embodiments, the front panel 2200 and the rear panel 2100 may be made of polycarbonate. It will be appreciated that polycarbonate is more impact resistant than polystyrene and provides ultraviolet (UV) light protection over polystyrene. For this reason, polycarbonate may be preferable over polystyrene or other materials to protect the collectible objects from impacts of the collectible-protective apparatus 100 and UV light.

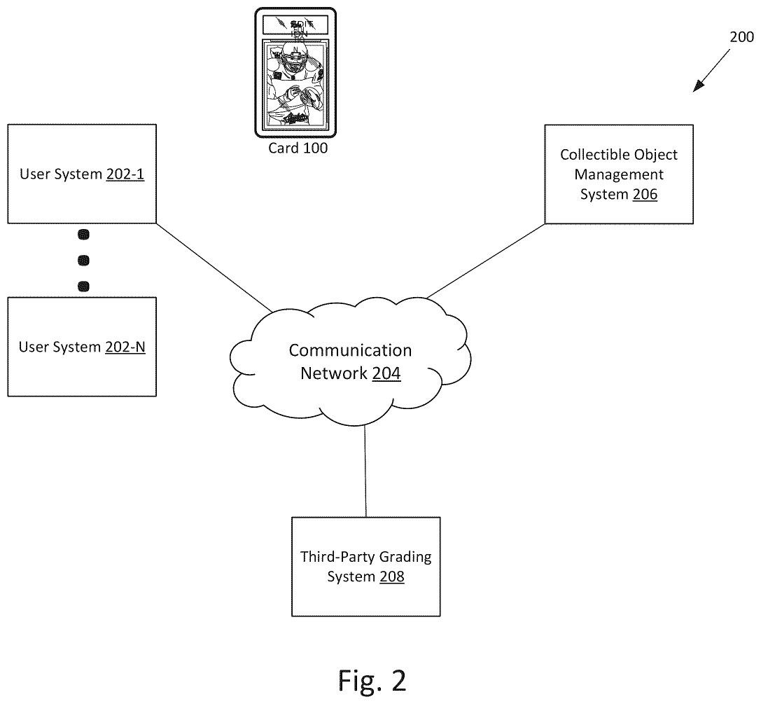

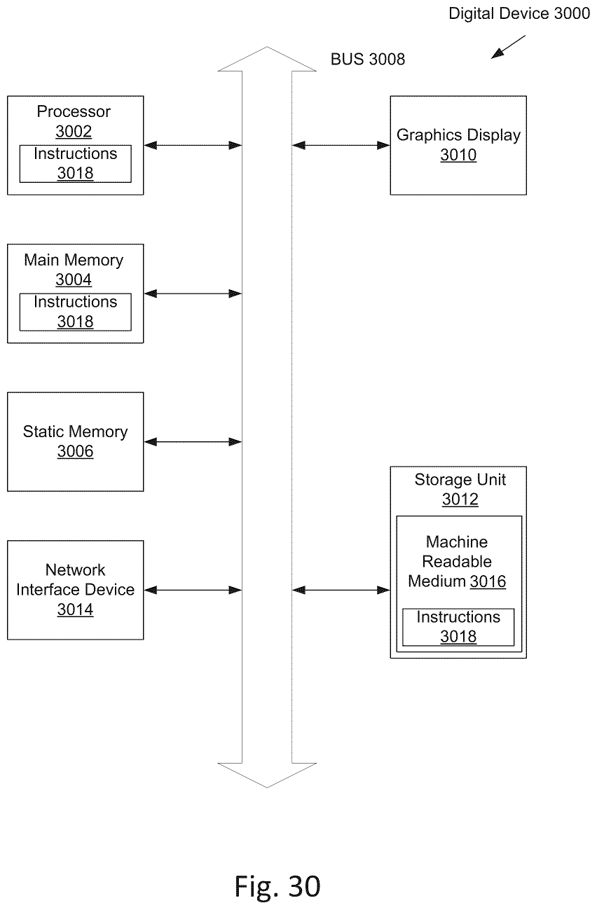

FIG. 2 depicts an example environment 200 capable of allowing users to associate digital media with a collectible-protective apparatus and collectible object protected therewithin according to some embodiments. The example environment 200 includes user systems 202-1 to 202-N (individually, user system 202 collectively), a communication network 204, a grading system 206, and a third-party grading system 208. The user systems 202-1 to 202-N, the collectible object management system 206, and the third-party grading system 208 may each be or include any number of digital devices. Digital devices are further discussed herein (e.g., see FIG. 30).

In some embodiments, user system 202-1 may be configured to facilitate communication between users and other associated systems. In some embodiments, the user system 202-1 may be or include one or more mobile devices (e.g., smartphones, cell phones, smartwatches, tablet computer, or the like), desktop computers, laptop computers, and/or the like. In some embodiments, the user system 202-1 may include an image capture device that allows a user of the user system 202-1 to capture digital images or digital video of collectible-protective apparatus 100. The user system 202-1 may upload the digital images or digital video of the collectible-protective apparatus 100 to the collectible object management system 206 for grading. In various embodiments, the user system 202-1 may upload the digital images or digital video of the collectible-protective apparatus 100 to the collectible object management system 206 or the third-party grading system 208.

In some embodiments, communication network 204 represents one or more computer networks (e.g., LANs, WANs, and/or the like). The communication network 204 may provide communication between any of user system 202, the collectible object management system 206, and the third-party grading system 208. In some implementations, the communication network 204 comprises computer devices, routers, cables, uses, and/or other network topologies. In some embodiments, the communication network 204 may be wired and/or wireless. In various embodiments, the communication network 204 may comprise the Internet, one or more networks that may be public, private, IP-based, non-IP based, and so forth.

In some embodiments, users may interact with user system 202 using, for example, a web browser or mobile application to communicate with other users, access web pages on the collectible object management system 206, or the third-party grading system 208.

In some embodiments, the collectible object management system 206 may utilize machine-learning algorithms to categorize a collectible object based on digital images or digital video received by the collectible object management system 206. For example, a user may take an image of both sides of a collectible card and provide the images to the collectible object management system 206. The collectible object management system 206 may then analyze the images using the machine-learning algorithms.

In one example, the owner of the collectible card may send the images of the physical collectible card to a card grading system, the card grading system. In some embodiments, the grading system 206 or the third-party grading system 208 may capture digital images or digital video of the collectible card for purposes of grading the collectible card. The digital images may include close-up or zoomed-in digital images of areas of the collectible card, such as one or more corners of the card, a central area of the collectible card depicting an athlete, or any imperfections which may appear on the collectible card.

In another example, the owner of the collectible object may send or provide access of the physical collectible object (protected or not protected by the collectible-protective apparatus 100) to the grading system 206 or the third-party grading system 208 which may grade and then return the collectible object to the user.

The third-party grading system 208 may provide grades or indications of the quality of the collectible object. In some embodiments, the third-party grading system 208 may allow users to buy or sell collectible objects (e.g., protected by the protective apparatus 100) online.

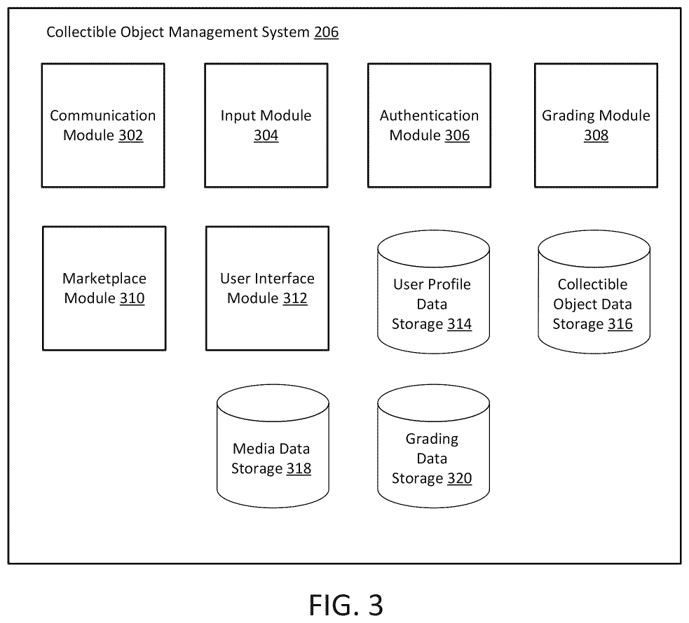

FIG. 3 depicts a block diagram of an example collectible object management system 300 according to some embodiments. The collectible object management system 300 includes a communication module 302, an input module 304, an authentication module 306, a grading module 308, a marketplace module 310, a user interface module 312, a user profile data storage 314, a collectible object data storage 316, a media data storage 318, and a grading data storage 320.

The communication module 302 may send and receive requests or data between any of the modules or data storages of the collectible object management system 206. The communication module 302 may send and receive request or data between any of the user system 202, the collectible object management system 206, and the third-party grading system 208.

In some embodiments, the input module 304 may receive requests or data from any of the modules or data storages of the collectible object management system 206. The input module 304 may send and receive requests or data between any of the user systems 202, the collectible object management system 206, and the third-party grading system 208.

In one example, the authentication module 306, authenticates a user's login and password or other identification authentication data. The login and password may be associated with the user's account. The authentication module 306 may authenticate a user by comparing the user's login and password with a database of registered users. It will be appreciated that users may be authenticated in many ways including, but not limited to, device identifiers, biometrics, encryption keys, cookies, and/or the like. In some embodiments, the authentication module 306 may, after authentication, determine data permissions prior to allowing users to access the contents within the user profile data storage 314. In some embodiments, the authentication module 306 requires proof of access to one or more collectible cards by requiring an identification number associated with the collectible (e.g., a certificate number) and/or an identifier associated with the collectible-protective apparatus 100 (such as a number etched in the collectible-protective apparatus 100).

The grading module 308 may provide grades or indications of the quality of the collectible object. The grading module 308 may allow users to buy or sell collectible objects (e.g., protected by the collectible-protective apparatus 100) online.

In some embodiments, the grading module 308 may utilize machine-learning algorithms to categorize a collectible object based on digital images or digital video received by the grading module 308. For example, a user may take an image of both sides of a collectible card and provide the images to the grading module 308. The grading module 308 may then analyze the images using the machine-learning algorithms.

Alternately, in some embodiments, the user may send or have the collectible card sent to the grading module 308 (e.g., through secure delivery). The collectible card may be inspected and scanned (e.g., using high-quality scanners, cameras, or mobile devices). The grading module 308 may then analyze the images using the machine-learning algorithms. Once graded, the collectible card may be secured within the collectible-protective apparatus 100. The grade and grading system may be identified on the collectible-protective apparatus 100 (e.g., through information that is contained within the collectible-protective apparatus 100 but is viewable through the upper window or otherwise detectable by the security features). The collectible card and the collectible-protective apparatus 100 may then be returned to the user.

In some embodiments, the grading module 308 uses a consistent, duplicable grading methodology that allows for consistent grades and consistent evaluation. For example, the grading module 308 may utilize a completely computational approach (e.g., using machine optical evaluation) to evaluate the collectible card. The grading methodology may be labeled or named such that when the grading methodology changes, there is a new label or name for the grading methodology. The label or name for the grading methodology used to grade a collectible card may be identified on the collectible-protective apparatus 100 (e.g., through information that is contained within the collectible-protective apparatus 100 but is viewable through the upper window or otherwise detectable by the security features). This allows for consistency, repeatability, and dependability of the grading which may impact the value of the collectible card.

Grading of a collectible card may be based on properties of the card such as centering of images on the card, sharpness of the corners of the card, gloss on the card, fading of pictures, degradations of card stock quality, and the presence of any imperfections. The grading card may include a score or category of the collectible card based on the properties of the collectible card. The grading card may be placed in an upper window portion of the collectible-protective apparatus 100, while the collectible card is placed in a lower window portion of the collectible-protective apparatus 100.

In various embodiments, the grading module 308 may receive images of the collectible card. The grading module 308 may apply image segment analysis to identify pixels and/or sets of pixels within the images and then make comparisons against trained featured for comparison of quality of colors, saturation of colors, sharpness of corners, gloss, indications of card stock quality, marks, and/or any imperfections. The result of the image segment analysis may be a set of features that are scored for an overall grade. In some embodiments, the images used by the grading module 308 to grade the collectible object may be stored in the collectible object data storage 316.

It may be appreciated that by using a completely computational approach and avoiding manual evaluation (even manual expert evaluation), the grading is consistent and reproducible.

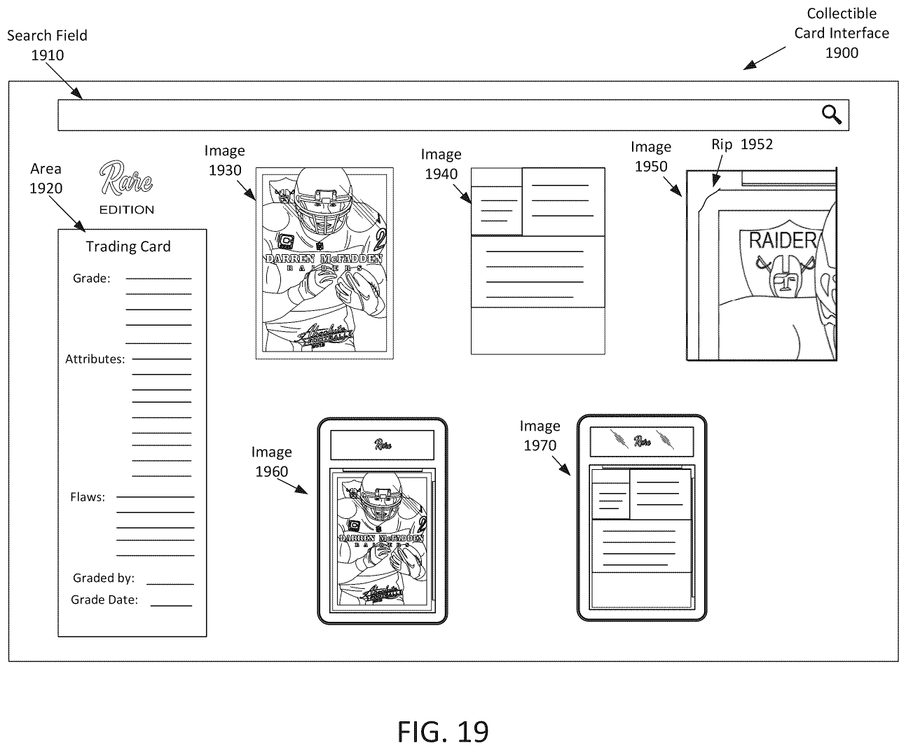

In some embodiments, the grading module 308 may provide a collectible card interface, such as a collectible card interface 1900 of FIG. 19. Further details regarding the collectible card interface will be discussed in FIG. 19.

In one embodiment, the marketplace module 310 provides an online platform to connect users to buy or sell graded or ungraded collectible cards. The marketplace module 310 may utilize images stored in the collectible object data storage 316 and/or indications of evaluation, quality, and grading stored in the grading data storage 320 (and/or the third-party grading system 208). In various embodiments, by using the grading module 308 and the third-party grading system 208, the history of ownership, quality of the card, and history of the card may be tracked. The marketplace module 310 may provide the history of ownership, quality of the card, and history of the card as a historical provenance regarding the particular collectible thereby improving tracking, reducing counterfeits, reducing opportunities for tampering, providing contact information for any entity that may have altered the collectible, and the like. This information improves the certainty of the quality of the collectible and improves the overall value of the collectible for later sale or purchase.

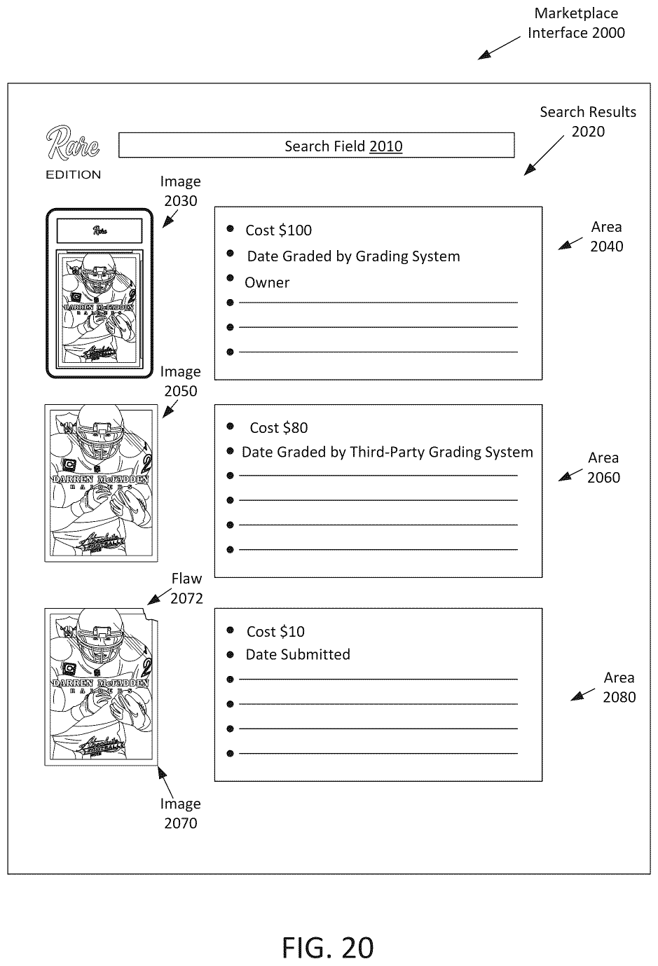

In one example, the marketplace module 310 may provide a user interface, such as the market interface 2000 of FIG. 20. Further details regarding the marketplace interface will be discussed in FIG. 20.

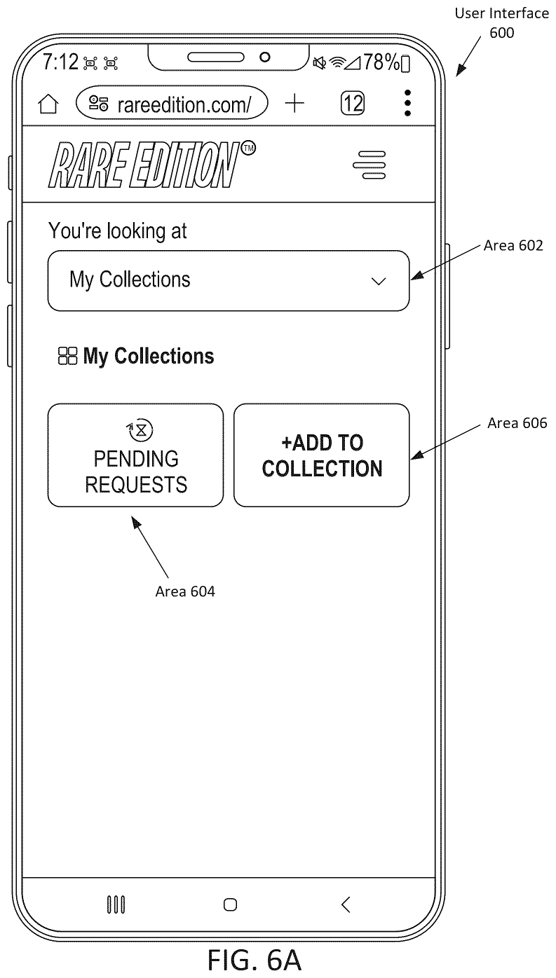

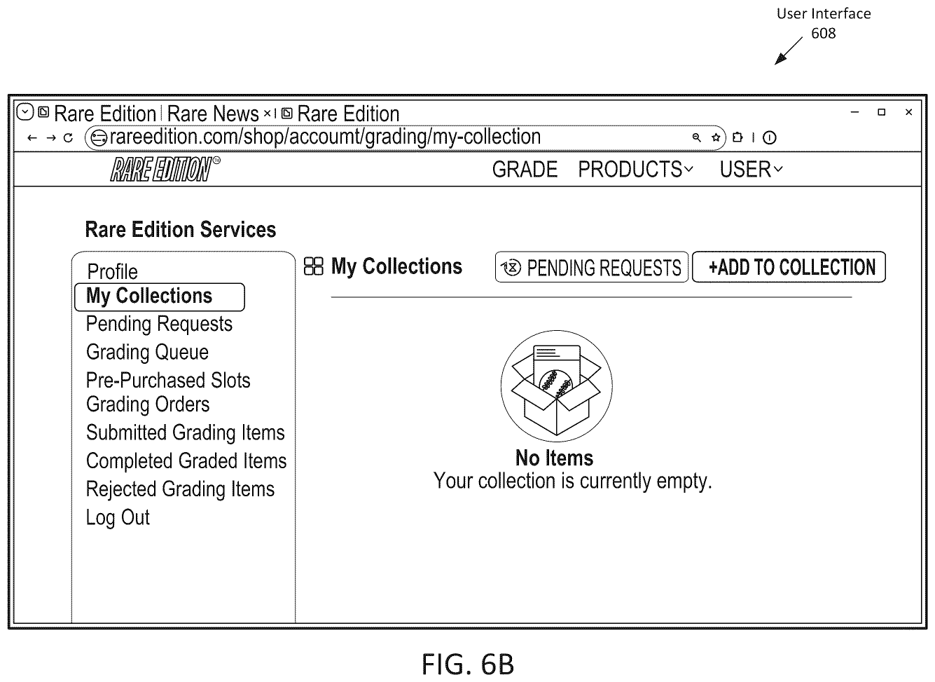

The user interface module 312 provides user interfaces to display interfaces, such as a video display unit, examples of which include liquid-crystal display (LCD), organic light-emitting diode (OLED), or cathode ray tube (CRT). An example of user interfaces provided by the user interface module 312 includes an example user interface 600 of FIG. 6A.

The user profile data storage 314 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and the like). The user profile data storage 314 includes user profile entries. Each user profile entry may be associated with a user of the collectible object management system 206. User profile entry includes information such as login or username and password.

Digital media of graded or ungraded collectible cards may be stored in the collectible object data storage 316. The collectible object data storage 316 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and/or the like). The collectible object data storage 316 may include collectible object records. Collectible object records may include any information about the collectible object and/or digital media (e.g., stored by the user).

In some embodiments, the collectible object records may include information such as one or more identifiers that enable a user to access, store, edit, remove, any number of digital media. In one example, the identifiers may include information such as a collectible object identifier and a collectible protective apparatus identifier. These two pieces of information may uniquely identify a particular copy of a collectible object that has previously been graded by the collectible object management system 206 and placed within a particular collectible-protective apparatus 100.

The records may include a grading of the collectible object, properties of the collectible object, a date of when the collectible object was received by the grading module 308, a date of when the collectible object was graded, a user account associated with the person who submitted the collectible object to the grading module 308. In various embodiments, collectible object entries may store the profile of users who submitted the collectible object for grading. In some embodiments, collectible object entries include categorical identifiers such as sports cards and non-sports cards. Sports cards may include collectible cards depicting images of athletes who are members of various professional and amateur sports teams. Non-sports cards may include collectible card games such as POKEMON or MAGIC THE GATHERING.

The media data storage 318 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and the like). The media data storage 318 may store digital media associated with a particular collectible object and a particular collectible-protective apparatus. In one example, the media data storage 318 includes object-apparatus data entries. Each apparatus data entry may be associated with one particular combination of collectible-object/collectible-protective apparatus. In various embodiments, each data entry may be associated with one particular collectible object.

The digital media may be a digital image, a digital video, digital audio file, virtual reality file, augmented reality file, and the like. In various embodiments, each apparatus data entry includes viewing permission associated with the digital media, these viewing permissions may be determined by the user who uploaded the digital media to the collectible object management system 206. In one example, viewing permission is determined by a copyright holder and/or person who provided the digital media to the collectible object management system 206. Viewing permissions determine who has authorization to view a digital media associated with a particular collectible object or a particular collectible-protective apparatus and a collectible object stored within. In some embodiments, a viewer or potential viewer of a particular digital media is required to input a passcode or password before viewing the digital media. In one example, a user may choose to make the digital media public and viewable by anyone.

In some embodiments, each combination of a collectible-object identifier and a collectible-protective apparatus identifier may be associated with different digital media. In one example, two people may have a copy of a particular collectible object (e.g., two copies of the same collectible baseball card). The combination of the collectible-object identifier and the collectible-protective apparatus identifier may enable a user to access digital media stored by the different card owners. In some embodiments, the collectible-object identifier is the same or similar for all copies of the same collectible. In other embodiments, the collectible-object identifier is different for all or most collectible objects that are stored in different collectible-protective apparatuses 100.

The grading data storage 320 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and the like). The grading data storage 320 includes grading entries. Each grading entry may include a score or category of a particular copy of a collectible card based on the properties of the collectible card. In some embodiments, grading entries include results of the grading module 308 such as properties of the card which were utilized to determine the grading of the collectible card. Properties include centering of images on the card, sharpness of the corners of the card, gloss on the card, fading of pictures, degradations of card stock quality, and the presence of any imperfections. In some embodiments, grading entries include information such as the history of ownership, quality of the card, and history of the card as a historical provenance regarding the particular collectible thereby improving tracking, reducing counterfeits, reducing opportunities for tampering, providing contact information for any entity that may have altered the collectible, and the like.

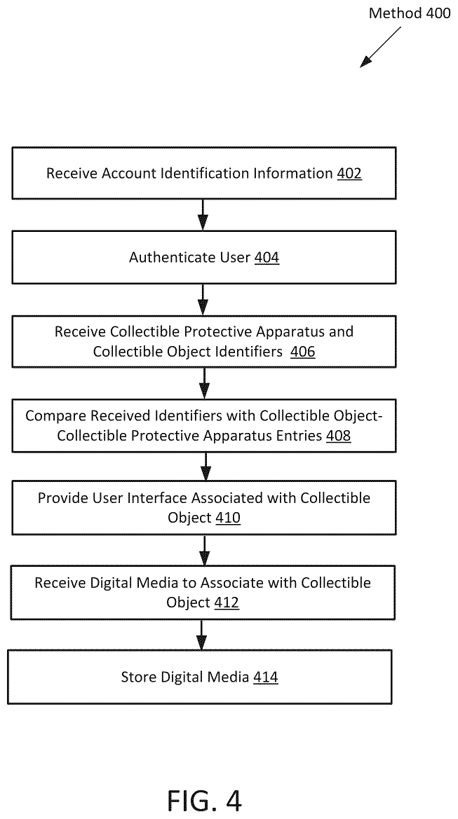

FIG. 4 depicts a method 400 of storing digital media with a collectible-protective apparatus and a particular copy of a collectible object stored therewithin according to some embodiments. The method 400 begins with step 402.

In step 402, the input module 304 receives login and password may be associated with a user's account. The login and password may be set by the user when the user registers.

In step 404, the authentication module 306 may authenticate the user by comparing the user's login and password with user profile entries stored in the user profile data storage 314. In some embodiments, the authentication module 306 requires one or more identifiers (e.g., a collectible object identifier or a collectible-protective apparatus identifier that may be printed on the apparatus). The authentication module 360 may authenticate the user and/or determine if the user has access rights to store, remove, and/or view digital media associated with the one or more identifiers.

Once the user has been authenticated as an authorized user of the collectible object management system 206, step 406 will proceed. In step 406, the user may interact with the user interface 600 of FIG. 6A to access a variety of functionality made available by the collectible object management system 206. For example, the user may interact with area 602 to access a collection of collectible objects associated with the collectible object management system 206. The user may interact with area 604 to access a user interface showing one or more collectible objects that the user has sent to the collectible object management system 206 for grading.

In some embodiments, after the collectible object management system 206 grades the user's collectible object, the collectible object management system 206 may protect the user's collectible object by placing it in a collectible-protective apparatus, such as collectible-protective apparatus 800 (e.g., collectible-protective apparatus 100) which, in this example, includes a collectible object 802, in which case is a collectible card of the former football player, Tom Brady.

The user interface 600 may be a mobile user interface provided by the user interface module 312 of the collectible object management system 206 to the user when the user is accessing the collectible object management system 206 using a mobile computing device such as a smartphone.

In another example, the user interface module 312 of the collectible object management system 206 may provide a local user interface 608 of FIG. 6B, allowing the user to access information regarding collectible objects submitted by the user.

In one example, the user interface 600 or the local user interface 608 allows a user to access digital media associated with a collectible object. The digital media may be uploaded by an uploading user (e.g., the user who has access to the identifiers indicating they have access to the collectible and/or the collectible-protective apparatus 100). The uploading user may determine who can access the digital media. In some embodiments, the uploading user may only allow users of the collectible object management system 206 who have physical access to a particular collectible object protected by a particular collectible-protective apparatus.

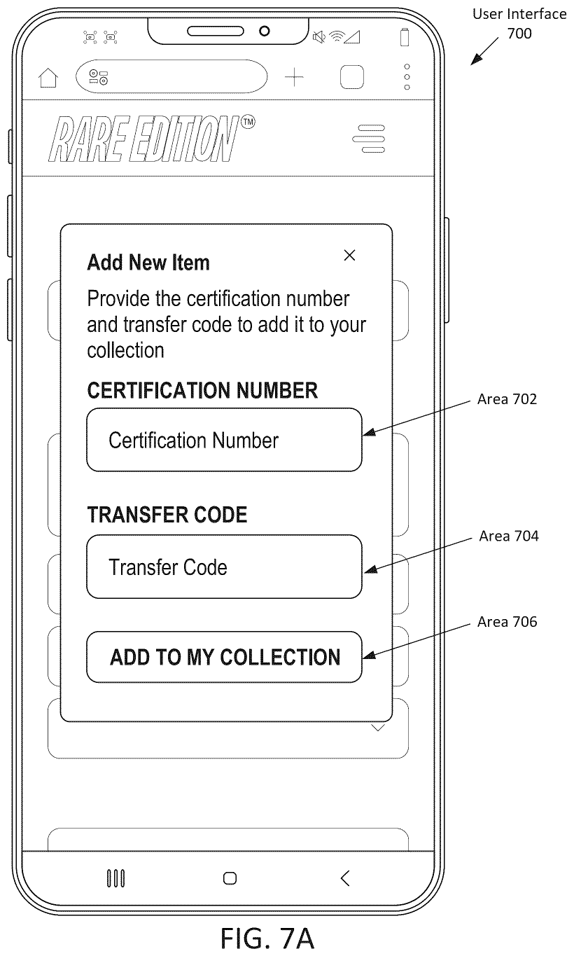

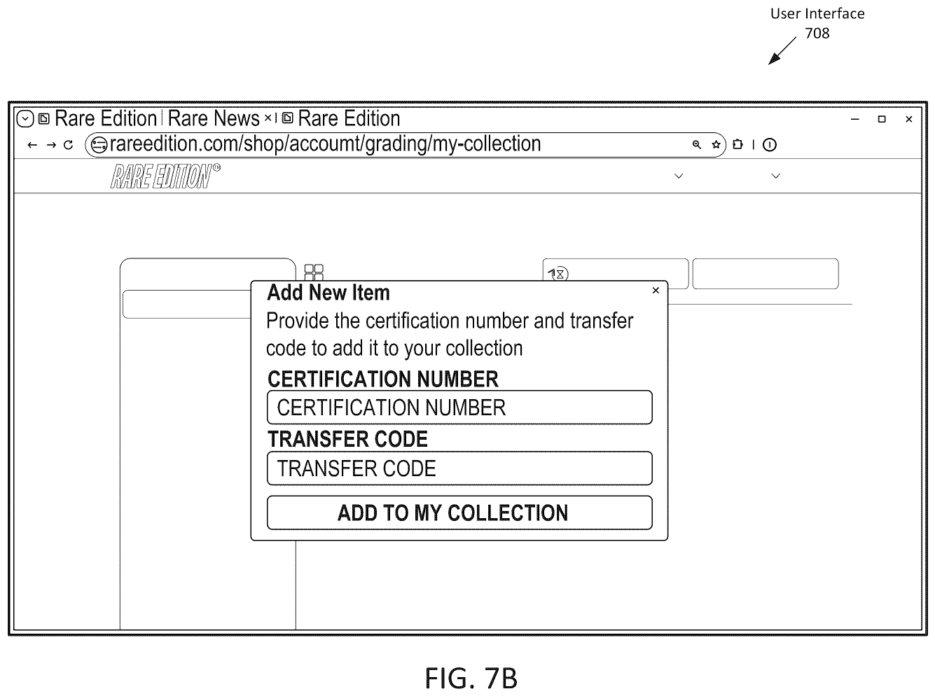

The user may interact with area 606 to add to a user's virtual collection of collectible objects. In response to this interaction, the user interface module 312 may provide an example user interface 700 of FIG. 7A.

In one example, step 406, the input module 304 receives a collectible object identifier and a collectible protective apparatus identifier. Although FIG. 4 and some examples herein include both a collectible object identifier and a collectible protective apparatus identifier, it will be appreciated that there may be only one identifier (e.g., either a collectible object identifier or a collectible protective apparatus identifier). In one example, the collectible protective apparatus may include only the collectible protective apparatus identifier etched within the collectible protective apparatus.

In some embodiments, the collectible protective apparatus does not include a collectible protective apparatus identifier etched or visible in the collectible protective apparatus. In one example, the NFC and/or RFC (or other active or passive electronic system) may provide the collectible protective apparatus identifier to a scanning system (e.g., such as a smart phone, tablet, or other digital device).

The user may provide these two pieces of identification information by interaction with fields 702 and 704 of FIG. 7A respectively. After the user inputs the information in fields 702 and 704, the user may interact with an area 706. In response to this interaction, the input module 304 may receive the certification number and transfer code provided in the fields 702 and 704.

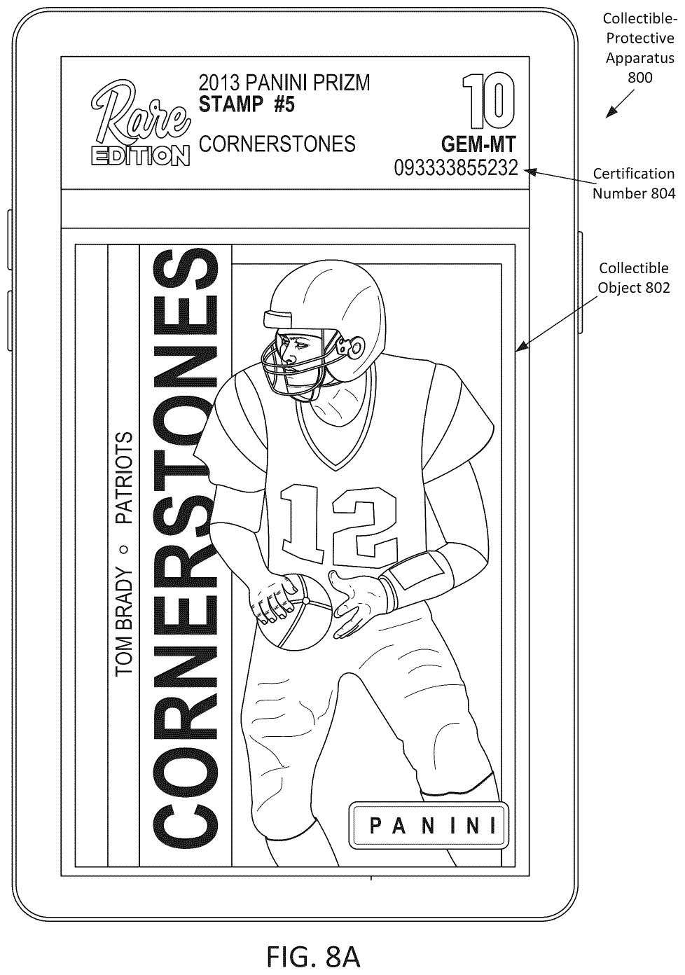

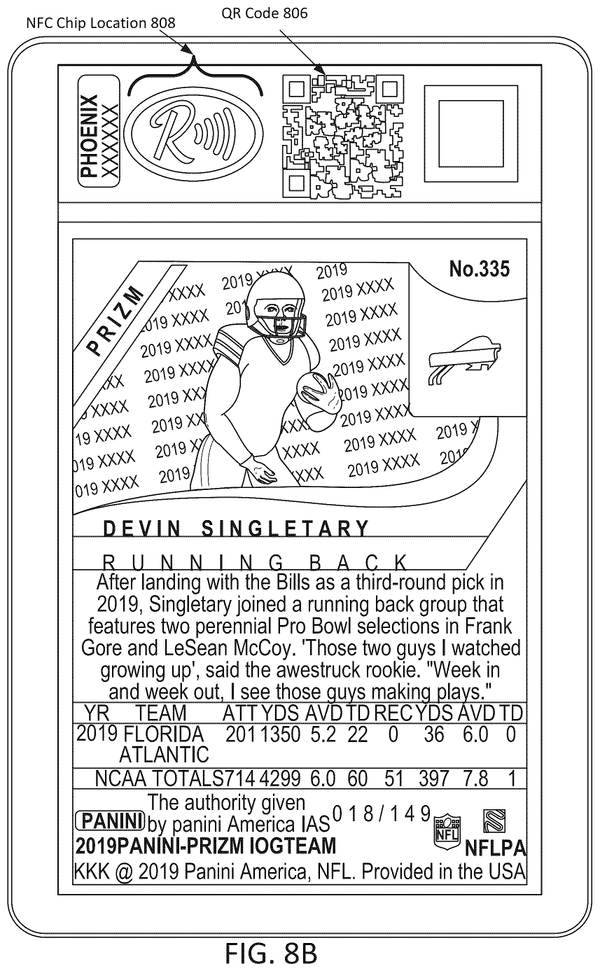

The user may input a collectible object identifier as the certification number to field 702. The collectible object identifier may be a certificate number found on a graded collectible card. An example of a collectible object identifier is the certification number 804 of FIG. 8A. An owner of a collectible object such as a collectible card may send a request to the collectible object management system to grade their collectible card based on their physical condition. The collectible object management system 206 may grade the object, place the collectible object in a collectible-protective apparatus along with a grading certificate which uniquely identifies the particular copy of a collectible card.

In some embodiments, the collectible object identifier is not visible in the collectible protective apparatus. In one example, the NFC and/or RFC (or other active or passive electronic system) may provide the collectible object identifier to a scanning system (e.g., such as a smartphone, tablet, or other digital device).

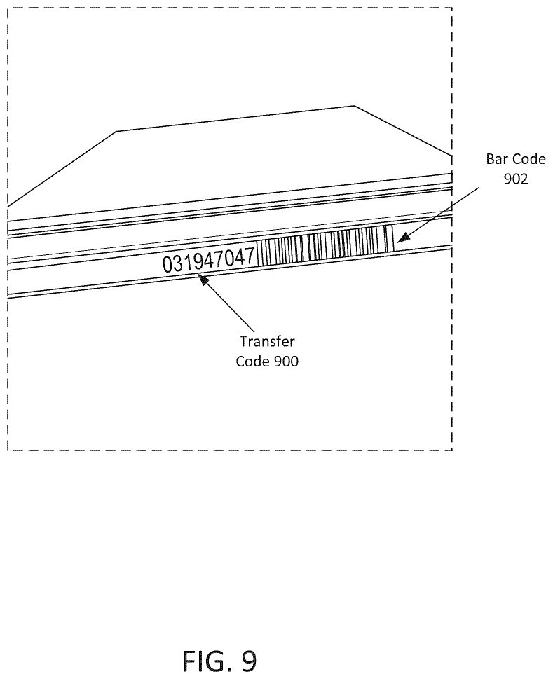

The user may input a collectible protective apparatus identifier as the transfer code to field 704. The collectible protective apparatus identifier may be a transfer code found on the collectible protective apparatus identifier. An example of the collectible protective apparatus identifier is a transfer code 900 of FIG. 9. In one example, the transfer code 900 is printed or etched on a bottom edge of the collectible protective apparatus. The user may input the transfer code 900 to field 704. In the illustrated example, the transfer code 900 is numerical data. In another example, the collectible protective apparatus identifier is in the form of a bar code 902. The bar code 902 is a machine-readable code in the form of a pattern of parallel lines of varying widths.

In another example, the user may scan an RFID or NFC chip within the collectible protective apparatus with the user's digital device and then the user's digital device may automatically provide the collectible protective apparatus identifier to the interface (e.g., populate field 704).

In some embodiments, RFID and/or NFC chip may be configured to provide both the collectible protective apparatus identifier and the collectible object identifier (e.g., as the transfer code and the certification number) or only one identifier.

In some embodiments, the user interface 700 is a mobile user interface provided by the user interface module 312 of the collectible object management system 206 to the user when the user is accessing the collectible object management system 206 using a mobile computing device such as a smartphone.

In another example, the user interface module 312 of the collectible object management system 206 may provide a local user interface 708 of FIG. 7B, allowing the user to input the certification number and transfer code associated with the collectible object.

In step 408, the input module 304 may send a request to the collectible object data storage 316. The input module 304 may compare the collectible object identifier and a collectible protective apparatus identifier received in step 406 with collectible card entries of the collectible object data storage 316. The collectible object identifier and a collectible protective apparatus identifier may uniquely identify a particular copy of a collectible card that has previously been graded by the collectible object management system 206 and placed within a particular collectible-protective apparatus. It can be appreciated that there may be different copies of the same collectible object some of which may be associated with a collectible card entry of the collectible object data storage 316.

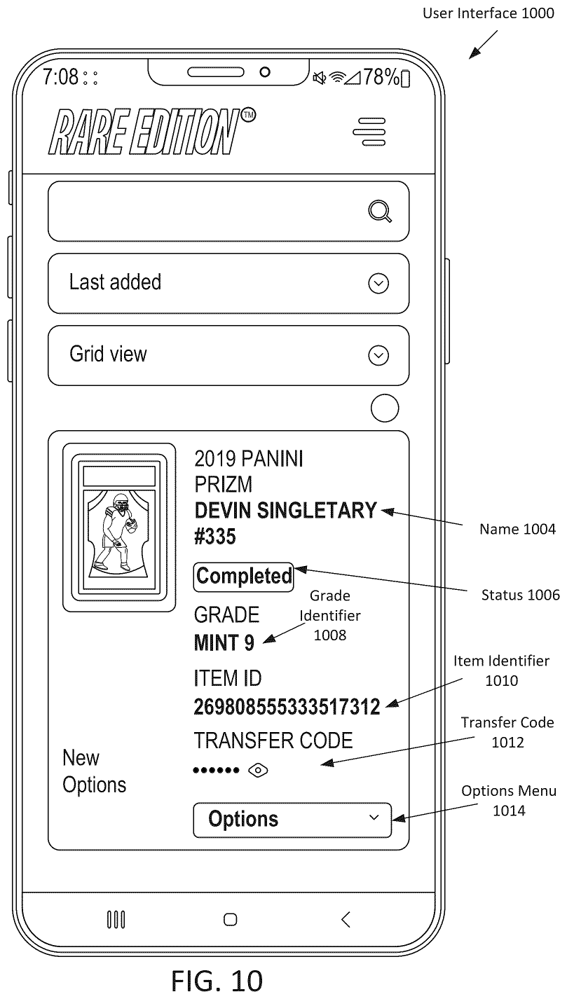

The input module 304 may determine that the collectible object identifier and a collectible protective apparatus identifier match one collectible card entry of the collectible object data storage 316. In response to this, the method 400 may proceed to step 410. In step 410 the user interface module 312 may provide a user interface associated with the particular collectible object. In one example, the user interface module 312 may provide a user interface 1000 of FIG. 10. The user interface 1000 includes a thumbnail image 1002 of the collectible object, a name 1004 of an athlete, character, or object corresponding to the collectible object, a grading status 1006, a grade identifier 1008, an item identifier 1010, a transfer code 1012, and an options menu 1014.

The optional thumbnail image 1002 may provide a small digital image of the collectible object. In this example, the name 1004 identifies the collectible card, in this case, athlete Devin Singletary, along with his jersey number “335.” The grading status 1006 indicates that the grading of this particular collectible object has been completed, and grade identifier 1008 identifies a numerical representation of the grade of the collectible object. The item identifier 1010 may represent a unique identification number associated with the collectible object which may be different from the certification number. The transfer code 1012 may correspond to the transfer code which may be printed or etched on the bottom edge of the collectible protective apparatus.

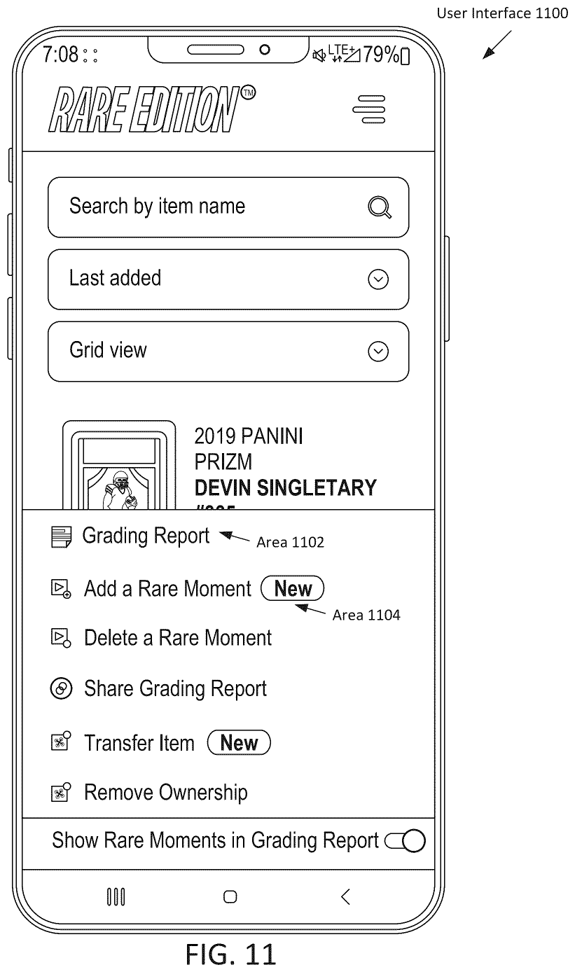

The user may interact with the options menu 1014 to view other functions available to the user by the collectible object management system 206. As seen in user interface 1100 of FIG. 11, the options menu includes options which allow a user to access a grading report, associate or add a digital media with a particular collectible object, remove a digital media with a particular collectible object, share a grading report with other people, transfer ownership of the particular collectible object to another user on the collectible object management system 206, or remove ownership of the particular collectible object. For example, if a user sells a collectible object, the user may wish to remove one or more digital media associated with the collectible object. The new owner of the collectible object may wish to associate different digital media with their newly acquired collectible object.

In another example, a particular digital media may make a particular collectible object especially valuable due to a rarity or limited availability of the digital media, in which case a transfer of the owner of a particular collectible object does not result in a removal of digital media.

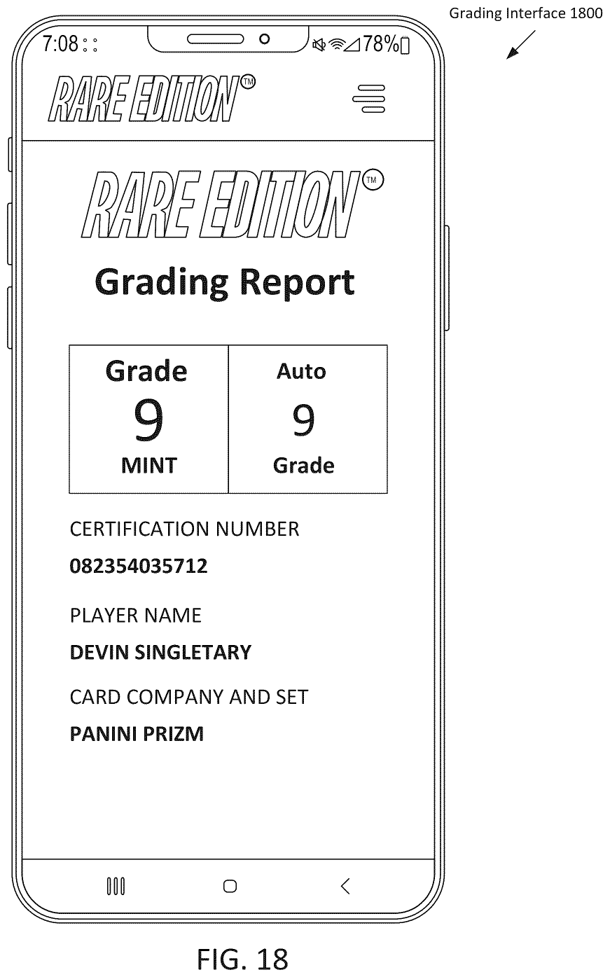

If a user interacts with area 1102 to access the grading report associated with the particular collectible object. In response to the user interacting with the 1102, a grading interface 1800 of FIG. 18 may be provided by the collectible object management system 206. The grading interface 1800 may provide additional information regarding the numerical grade provided by the grading module 308.

It can be appreciated that one particular copy of a collectible object may be associated with multiple digital media. Furthermore, one particular digital media may be associated with multiple copies of the same collectible object. Moreover, multiple digital media may be associated with multiple copies of the same collectible object. Likewise, different copies of the same collectible object may be associated with different digital media.

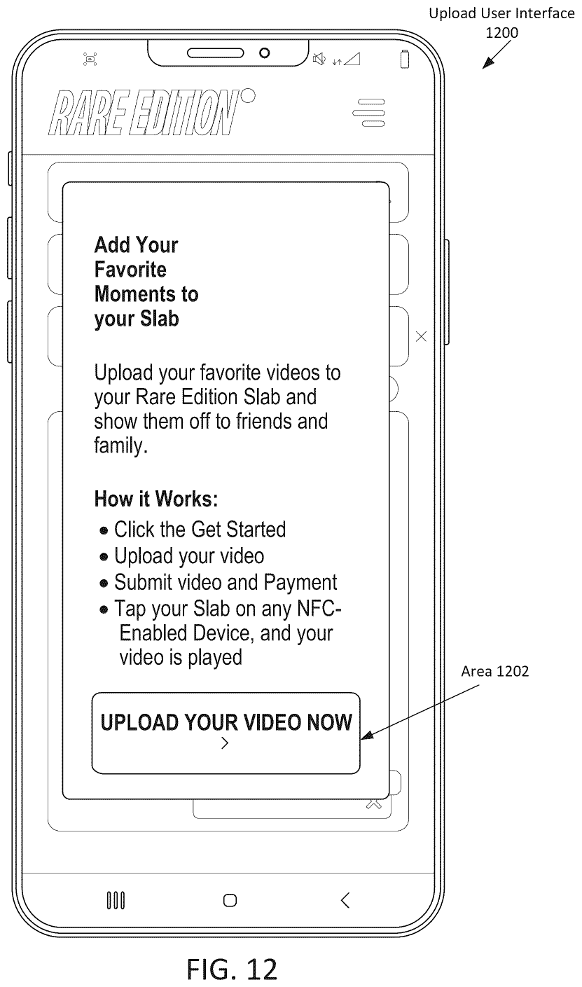

In step 412, the user may interact with area 1104 to add digital media to the particular collectible object such that other people, who may or may not have accounts with the collectible object management system 206, may view the digital media. The user interface module 312 may provide an upload user interface 1200 of FIG. 12. The user may interact with area 1202 to begin the process of uploading digital media.

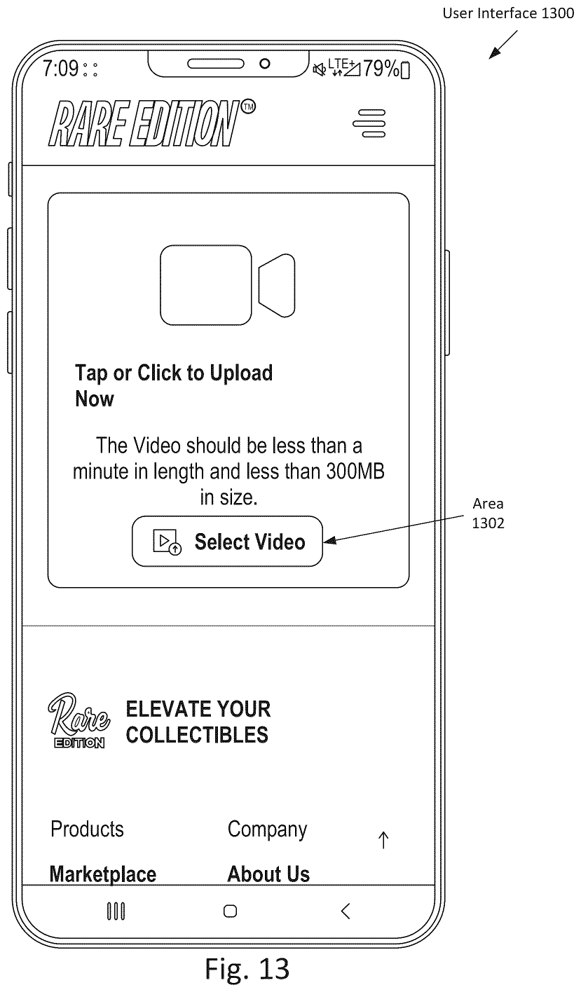

In response to the user interacting with area 1202, the user interface module 312 may provide user interface 1300 of FIG. 13. The user may interact with area 1302 to select a digital media such as a digital video to upload to the collectible object management system 206. In some embodiments, the collectible object management system 206 may have limitations on the size and/or length of the digital media that the user may upload.

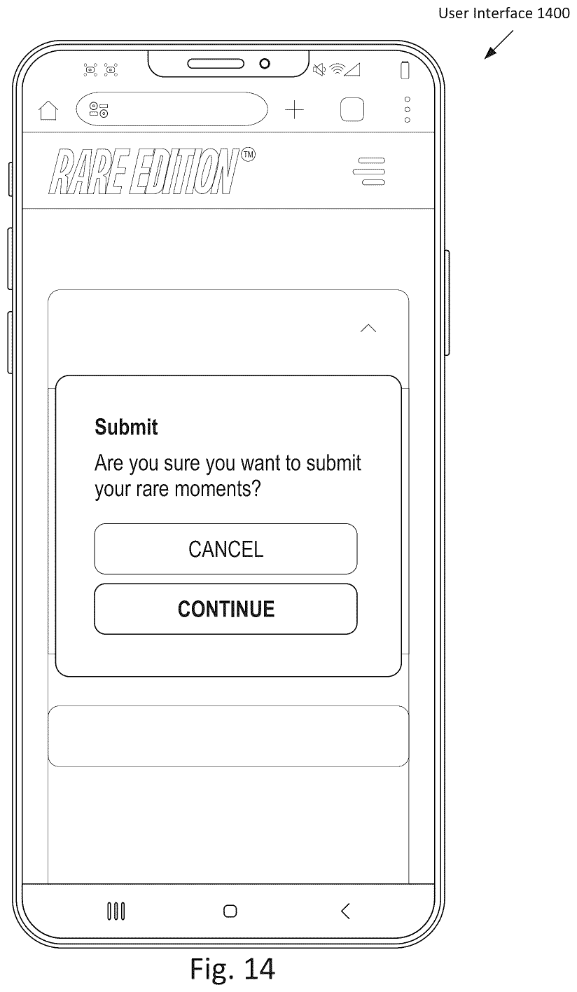

In step 414, the collectible object management system 206 may store the digital media in the media data storage 318. The user interface module 312 may provide a user interface 1400 of FIG. 14, requesting the user to acknowledge and submit the digital media and associate it with the particular collectible object.

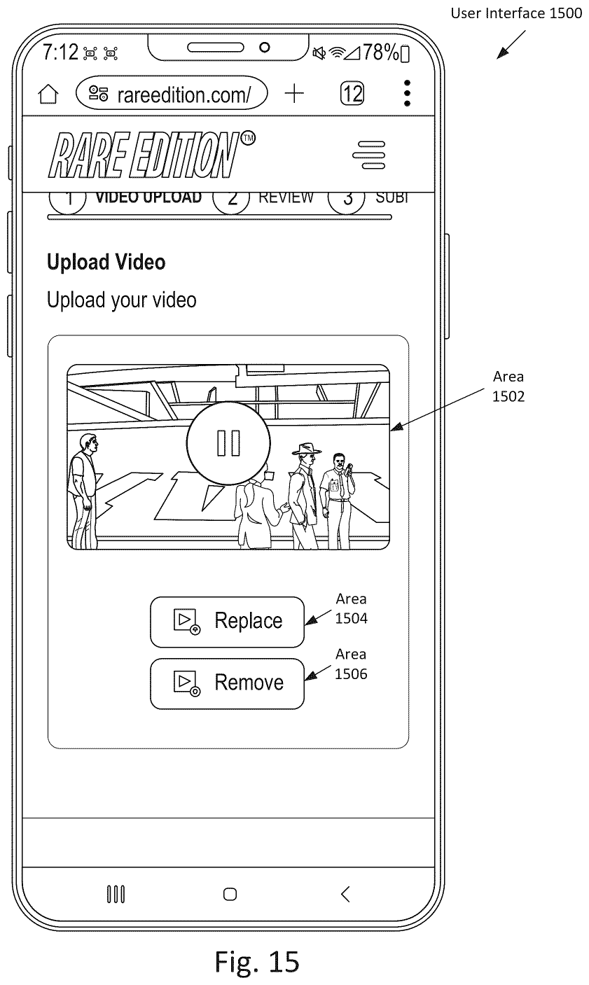

Subsequently, the user interface module 312 may provide a user interface 1500 of FIG. 15. The user interface 1500 includes an area 1502, allowing the user to preview the uploaded video. The user may choose to replace or remove the video provided in area 1502 by interacting with area 1504 or 1506 respectively.

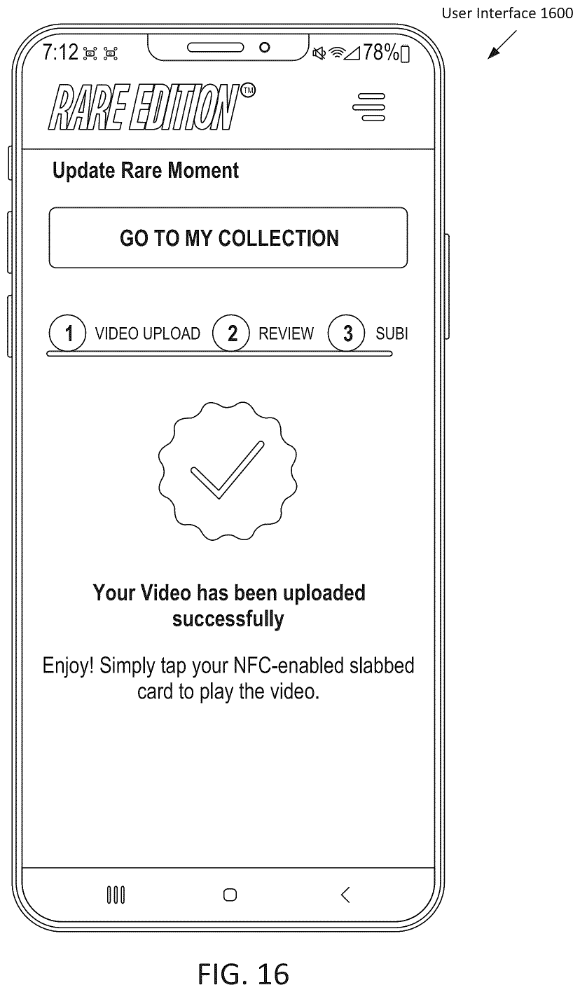

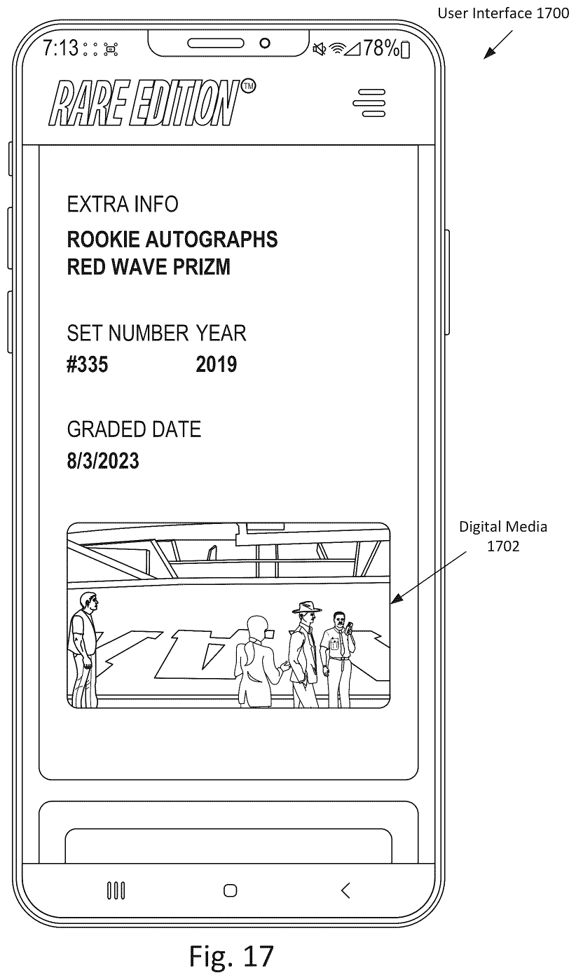

User interface 1600 of FIG. 16 may be provided by the user interface module 312 once the video has been successfully uploaded. Other people, who may or may not have accounts with the collectible object management system 206, may view the digital media by bringing an NFC-enabled mobile computing device in proximity to an NFC-enabled collectible-protective apparatus. In response to an NFC-enabled mobile computing device being in proximity to the NFC-enabled collectible-protective apparatus, a display unit of the NFC-enabled mobile computing device may be provided a user interface 1700 of FIG. 17 which provides some information regarding the collectible object such as a set number or year the collectible object was produced and a date the collectible object was graded as well as a digital media 1702 provided by a user of the collectible object management system 206. The digital media 1702 may be played in a loop.

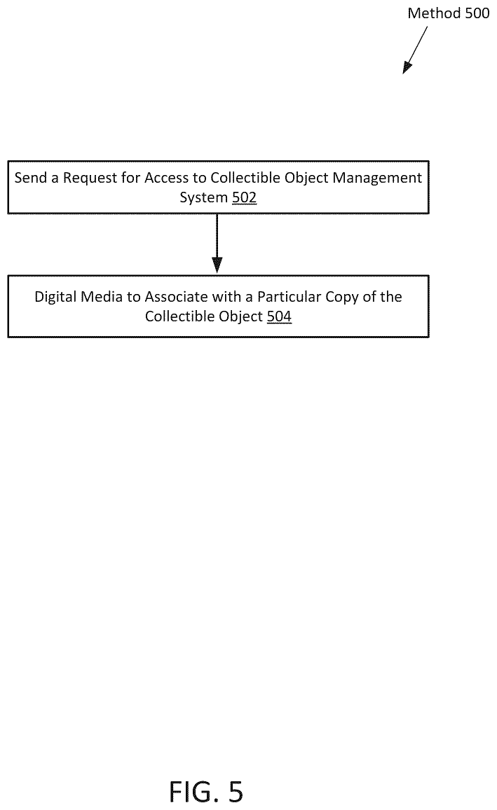

FIG. 5 depicts a method 500 of accessing digital media with a collectible-protective apparatus and a particular copy of a collectible object stored therewithin according to some embodiments. The method 500 begins with step 502. In this step, the input module 304 of the collectible object management system 206 receives a request to access the collectible object management system 206. In some embodiments, a user may make this request by bringing an NFC-enabled mobile computing device in proximity to an NFC-enabled collectible-protective apparatus. For example, the user may bring the NFC-enabled smartphone close to the NFC-enabled collectible-protective apparatus such as a collectible-protective apparatus 800 of FIG. 8A. The collectible-protective apparatus 800 includes an NFC chip or an RFID chip which enables short-range wireless communication between the mobile computing device and the collectible-protective apparatus 800. In some embodiments, the wireless communication includes an application programming interface (API) call to a Uniform Resource Locator (URL) associated with a login user interface of the collectible object management system 206.

In one example, if the user does not have access to an NFC-enabled smartphone, the user may access the URL associate with the login user interface of the collectible object management system 206 by using a web browser.

In another example, the user may access the URL associated with the login user interface of the collectible object management system 206 by interacting with the quick response (QR) code, such as a QR code 806 of FIG. 8B.

One or more NFC chips may be located within or on the collectible-protective apparatus 100. In some embodiments, an NFC chip may be located below a label or mask of the collectible-protective apparatus 100. In one example, an NFC chip is located below an icon indicating communication, such as in NFC chip location 808 (e.g., located underneath all or part of the R logo with the radio waves). It will be appreciated that the NFC chip may be any size and may be located in many different positions including, for example, the edge of the collectible-protective apparatus 100 (e.g., bottom or top edge of the collectible-protective apparatus 100), the face of the collectible-protective apparatus 100, or back of the collectible-protective apparatus 100.

In response to receiving the request in step 502, the collectible object management system 206 provides the user digital media associated with the particular copy of a collectible object. For example, the user interface module 312 of the collectible object management system 206 may provide the user interface 1700 of FIG. 17. The user interface 1700 which provides some information regarding the collectible object such as a set number or year the collectible object was produced and a date the collectible object was graded as well as a digital media 1702 provided by a user of the collectible object management system 206.

The person who uploaded the particular digital media associated with a particular collectible object may determine the viewing permission of the particular digital media. For example, a particular digital media associated with a particular collectible object may only be viewable by a person or people who have physical access to the particular collectible-protective apparatus and the particular collectible object stored therewithin. In various embodiments, the person or people only need to have physical access to the collectible object in order to be provided with the particular digital media associated with the particular collectible object. It can be appreciated that the person viewing the particular digital media may not need to have an account associated with the collectible object management system 206.

It can be appreciated that a particular collectible-protective apparatus and a particular collecting object protected therewithin may be associated with more than one digital media. In another example, a particular digital media may be associated with more than one collectible object. For example, members of an athletic team may record and upload a video message associated with a limited number of copies of a particular collectible trading card. Users who own one of the limited number of copies of the particular collectible trading card may be given permission by the collectible object management system 206 to view the video message. Having access to the video message may make the limited number of copies of the particular collectible trading card more valuable than other copies of the same particular collectible trading card which does not include access or permission to view the video message.

Different owners of different copies of the same collectible object may choose to associate different digital media with their respective copies of the same collectible object. For example, one user may associate one digital media with one particular copy of a collectible object. Another user may associate a different digital media with another copy of the same collectible object.

FIG. 19 depicts a collectible card interface 1900 containing information regarding a card in some embodiments. The collectible card interface 1900 includes a search field 1910, an area 1920, and images 1930 through 1170.

A user navigating a user interface of the collectible object management system 206 may be provided the user interface. The result of the search may be the collectible card interface 1900. Search criteria may include graded or ungraded cards, a categorical identifier may include sports cards or non-sports cards, type of sports, name of the sports team, type of collectible card game, a collectible card ranking. The grading module 308 may receive one or more search criteria and perform a search on the collectible card entries of the grading data storage 320. The output of the search may be a list of search results that includes one or more collectible card entries which at least one of the provided search criteria. The user may interact with one of the collectible cards in the list of search results. The grading module 308 may send a request to the grading data storage 320 for a particular collectible card entry. The grading data storage 320 may provide information regarding the particular collectible card. The particular collectible card entry may be a graded or ungraded collectible card. In some embodiments, the collectible card entry includes digital media associated with the particular collectible card entry captured by the grading module 308. The digital media may be provided to the collectible card interface 1900.

The area 1920 of the collectible card interface 1900 may include some information regarding the particular collectible card. Information may include the grade of the particular collectible card provided by the grading module 308. In some embodiments, the area 1920 may include a grade or rating provided by a different grading system such as the third-party grading system 208. In one example, the area 1920 may include properties of the particular collectible card such as attributes and flaws of the collectible card such as the sharpness of the corners of the collectible card, bends or breaks in the card, centering of images on the card gloss on the card, fading of pictures, degradations of card stock quality, and the presence of any imperfections or flaws.

The collectible card interface 1900 may include digital images of the particular collectible card. For example, the image 1930 depicts a view of the front of the particular collectible card, without the protective apparatus. The image 1930 includes a picture of a particular a certain person, such as an athlete, along with their name, the name of a professional or amateur sports team the athlete belongs to. The image 1940 depicts a view of the back of the particular collectible card. In some embodiments, the image 1940 includes a short description of the athlete, a description of the picture on the front view of the collectible card, statistics, or trivia.

The image 1950 depicts a zoomed-in or close-up of a top left corner of the collectible card. The collectible card interface 1900 may include images of a small area of the collectible with flaws or imperfections. For example, the top left corner of the collectible card includes a rip 1952. In some embodiments, the collectible card interface 1900 may include images of aspects or properties of the collectible card which support the grade or ranking given to the card. For example, if the collectible card has very sharp corners or the picture on the front of the collectible card is centered, the collectible card interface 1900 may include images that depict a close-up of these parts of the collectible card.

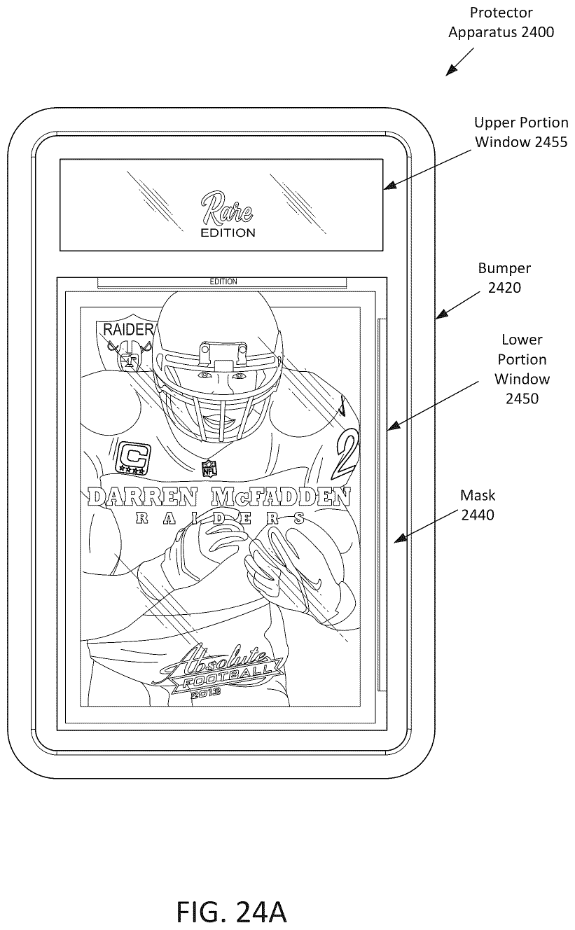

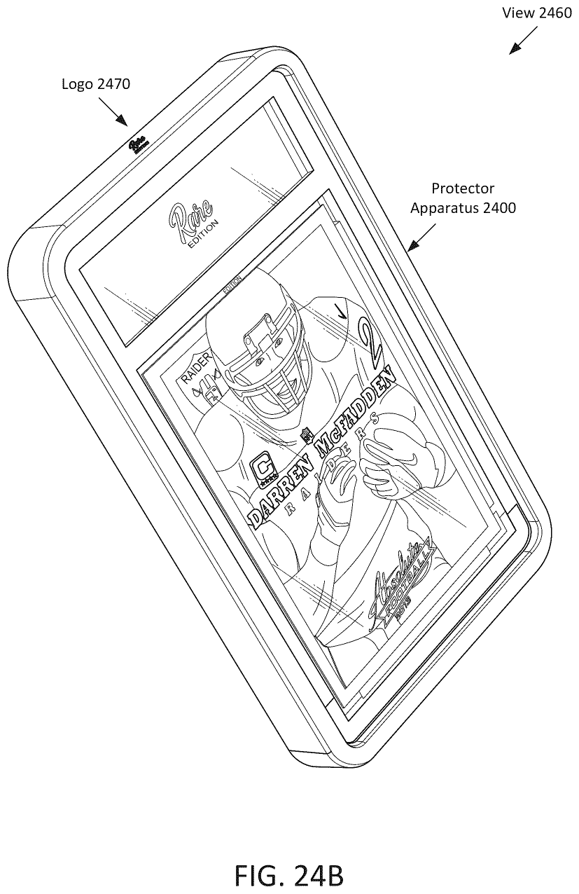

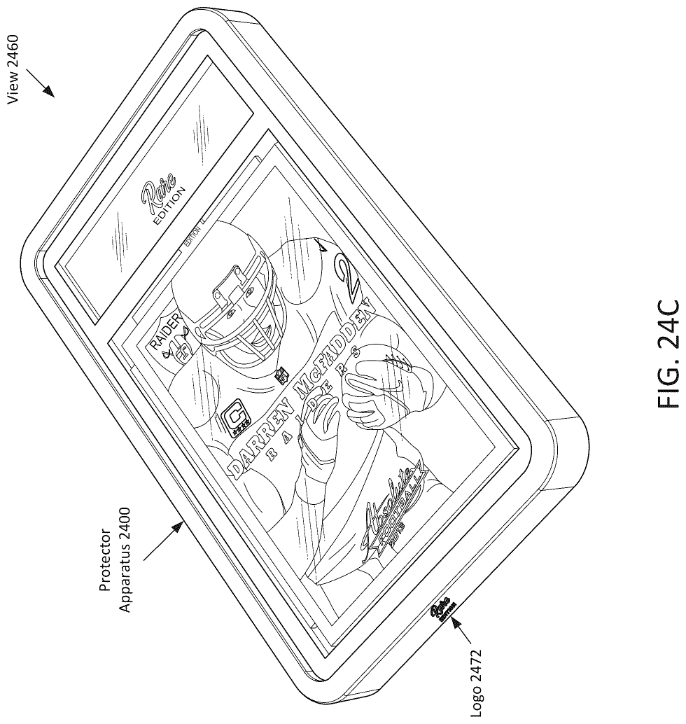

The collectible card interface 1900 may further include images 1950 and 1960, which depict a front and back view of the collectible card placed within a protective apparatus such as the collectible-protective apparatus 2400 of FIG. 24A.

FIG. 20 depicts a market interface 2000 in some embodiments. The market interface 2000 includes a search field 2010 and search results 2020.

A user may input one or more search criteria to the search field 2010. The search criteria may include graded or ungraded card, categorical identifier may include sports cards or non-sports cards, type of sports, name of the sports team, type of collectible card game, a collectible card ranking. The grading module 308 may receive the one or more search criteria and perform a search on the collectible card entries of the grading data storage 320. The output of the search may be a list of the search results 2020, which includes one or more collectible cards entries which at least one of the provided search criteria. Each collectible card entry may include digital images of a particular collectible card, along with data regarding the particular collectible card including the cost of the card, if the card has been graded, a name of the grading system which graded the card, owner of the card.

For example, an image 2030 of a first collectible card, information regarding the first collectible card can be found in area 2040. The area 2040 may include data such as a price for the card, a name of the grading system which graded the card, and a name of the owner of the card. Additional information may include properties of the first collectible card such as attributes or flaws.

The market interface 2000 may include images 2050 and 2070 of a second and a third collectible card respectively. Information regarding the second and the third collectible card can be found in areas 2060 and 2080. In the illustrated example of FIG. 19, the cost of the third collectible card may be lower when compared the first and second collectible cards because of a flaw 2072 or rip of the third collectible card. The user may zoom in or magnify a portion of each of the images 2030, 2050, and 2070. In some embodiments, the areas 2040, 2060, and 2080 each may include a uniform resource locator (URL) which may allow a tauser to purchase the collectible card.

FIG. 21A depicts a front side 2140 of a rear panel 2100 in some embodiments. FIG. 21B depicts a back side 2150 of the rear panel 2100 in some embodiments. The front side 2140 of the rear panel 2100 is typically on the inside of the collectible-protective apparatus 100 when the rear panel 2100 is joined to the front panel 2200. The back side 2150 is typically on the back, outward facing side when the rear panel 2100 and the front panel 2200 are joined.

The back side 2150 of the rear panel 2100 depicted in FIG. 21A includes a body 2110 with a perimeter member 2120 disposed along the perimeter of one side of the body 2110. The perimeter member 2120 may allow the front panel 2200 and the rear panel 2100 to be held together and/or may be used to hold the two halves together (e.g., through sonic or laser welding). In various embodiments, the perimeter member 2120 may prevent debris from entering into the collectible-protective apparatus 100. Further, the perimeter member 2120 may assist in reducing opportunities to tamper with the collectible-protective apparatus 100, reducing opportunities to tamper with a security feature of the collectible-protective apparatus 100 (e.g., NFC chip, hologram, RFID, or the like), or reducing opportunities to tamper with the collectible object. Laser welding may also assist to reduce the opportunity for water to enter into the collectible-protective apparatus 100.

In various embodiments, the perimeter member 2120 is laser welded to the elevated edge 2220 (discussed with regard to FIG. 22A). By laser welding the rear panel 2100 and the front panel 2200 may assist to prevent water from entering the collectible-protective apparatus 100 if the apparatus gets wet or is submerged. Further, laser welding the perimeter member 2120 to the elevated edge 2220 may prevent debris from entering into the collectible-protective apparatus 100, may reduce opportunity to tamper with the collectible object, and/or reduce opportunity to tamper with the security feature(s) of the collectible-protective apparatus 100 (e.g., NFC chip, hologram, RFID, or the like).

Supporting members 2130A, 2130B, and 2130C are rectangular protrusions that may assist in holding or positioning the collectible object. There may be any number of supporting members. In various embodiments, there is another supporting member that holds or positions one of the sides of the collectible object. The supporting members 2130A, 2130B, and 2130C may be any shape such as rectangular, circular (e.g., posts), polygonal, and/or the like. There may be any number of supporting members 2130A, 2130B, and 2130C.

The supporting members 2130A, 2130B, and 2130C (and any other supporting member) may extend the depth of the cavity defined by the rear panel 2100 and the front panel 2200 when joined together. For example, when the rear panel 2100 and the front panel 2200 are joined together, the supporting members 2130A, 2130B, and 2130C may extend from the rear panel 2100 to the front panel 2200 without a gap (or with only a small gap). There may be any number of supporting members. The supporting members may assist in holding the collectible object and/or providing strength and rigidity to the collectible-protective apparatus 100.

In various embodiments, supporting members 2130A, 2130B, and 2130C may be welded (e.g., sonically welded) such that the rear panel 2100 and the front panel 2200 are securely held.

While FIG. 21A depicts three supporting members 2130A, 2130B, and 2130C that are positioned to hold sides of the collectible object, it will be appreciated that there may be any number of supporting members. For example, in some embodiments, there may be only one supporting member that forms a perimeter about a cavity configured to hold the collectible object. In another example, rear panel 2100 may include supporting members configured to hold corners of the collectible object and/or sides of the collectible object.

The rear panel 2100 may be formed by injection molding along with the supporting members 2130A, 2130B, and 2130C. In some embodiments, the supporting members 2130A, 2130B, and 2130C are removable and able to be coupled to different places of the front side 2140 of the rear panel 2100 thereby allowing the collectible-protective apparatus 100 to hold and retain different sizes of collectible cards. In various embodiments, the supporting members may include supporting posts or protrusions that may fit in any number of holes positioned at specific spacing in the rear panel 2100 or the front panel 2200. The supporting members may be positioned using different sets of holes to allow different sizes and shapes of collectible objects to be held. In some embodiments, the supporting members may include magnets (e.g., rare earth magnets) that allow the supporting members to be held in place at different positions. In other embodiments, the supporting members may be adhered (e.g., using glue or melted plastic) to different positions to enable holding of different sizes of collectible objects.

The supporting member 2135 may be any shape. As depicted in FIG. 21A, the supporting member 2135 forms a perimeter about the upper portion 2145 and extends towards the lower portion 2142 to form a barrier to retain or hold a side of the collectible object. The supporting member 2135 surrounding the upper portion 2145 may be configured to retain, protect, or hold paper, media, or the like containing information such as a logo, information regarding the collectible object, a grade, a grading system, a security measure (e.g., holograph), and/or the like. In this example, a logo is etched upon the supporting member 2135 between the perimeter about the upper portion 2145 and the portion of the supporting member 2135 that is configured to hold the collectible object. The logo may be visible through the front panel 2200 (e.g., through a window of the front panel 2200).

In various embodiments, the supporting member 2135 may only surround the upper portion 2145 and there may be another rectangular member that forms a fourth supporting member to work with supporting members 2130A, 2130B, and 2130C to hold the collectible object.

The rear panel 2100 may include any number of supporting members and the supporting members may be of any shape. For example, the collectible-protective apparatus 100 may include a supporting member that surrounds the lower portion 2142 (e.g., the supporting member may be a rectangle that surrounds the lower portion 2142 much like the supporting member surrounds the upper portion 2145).

FIG. 21B depicts a back side 2150 of the rear panel 2100 that makes up the card protector in some embodiments. In some embodiments, the rear panel 2100 may be transparent, semi-transparent, or opaque. The back side 2150 may be of any texture. In various embodiments, the back side 2150 includes or retains security features (e.g., such as an NFC chip, RFID, a hologram, and/or the like).

Although the back side 2150 in FIG. 21B is featureless, it will be appreciated that there may be information on the back side 2150 such as information about the collectible card, grading system, features of the collectible-protective apparatus 100, and/or the like.

In some embodiments, the back side 2150 includes a transparent window similar to the transparent window on the front panel 2200 that is configured to depict a side of the collectible object. In one example, when the collectible object is a sports card, the front panel 2200 may include a transparent window allowing a user to view the image of the athlete on the front of the sports card and the rear panel 2100 may include a transparent window (e.g., of the same size and shape of the transparent window of the front panel 2200) to display the athlete's athletic statistics or other information from the back of the collectible card.

In various embodiments, the front side 2250 of the front panel 2200 of the collectible-protective apparatus 100 is transparent or semi-transparent. In some embodiments, the back side 2150 of the rear panel 2100 has a matte or glossy surface. In some embodiments, the rear panel 2100 and the front panel 2200 comprises or is covered by a strong, transparent panel, such as CORNING® GORILLA® glass, to provide added protection to the card protector. It will be appreciated that the protective apparatus may be fabricated of many different materials, including, for example, a combination of materials such as polycarbonate with cut outs that are coupled to a stronger material.

In some embodiments, the perimeter member 2120 may have a height of 1.5 mm from the surface of the body 2110. In some embodiments, the rear panel 2100 may have a width 2105. The width 2105 of the rear panel 2100 may be 80.33 mm.

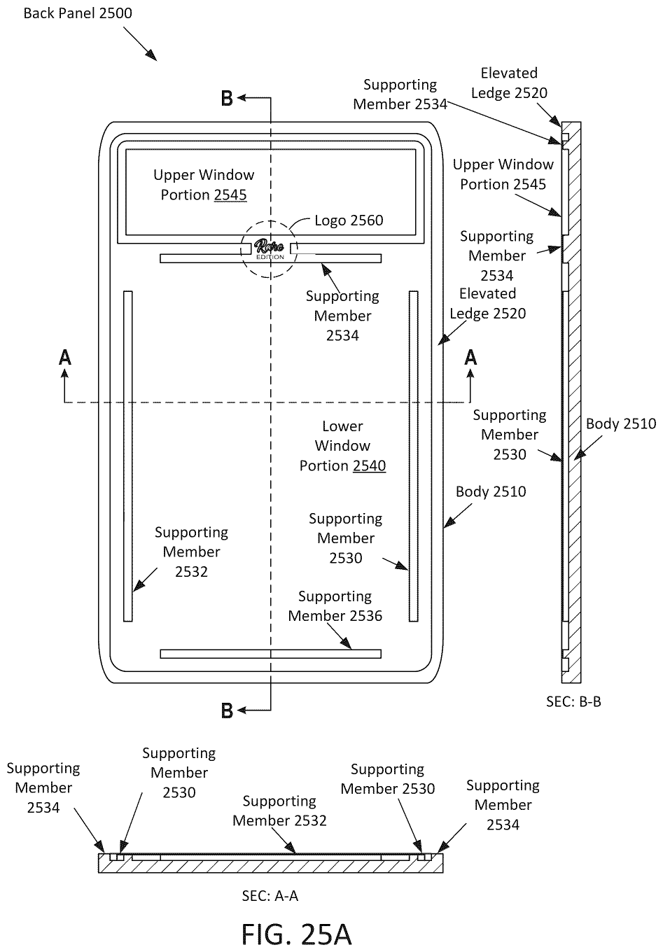

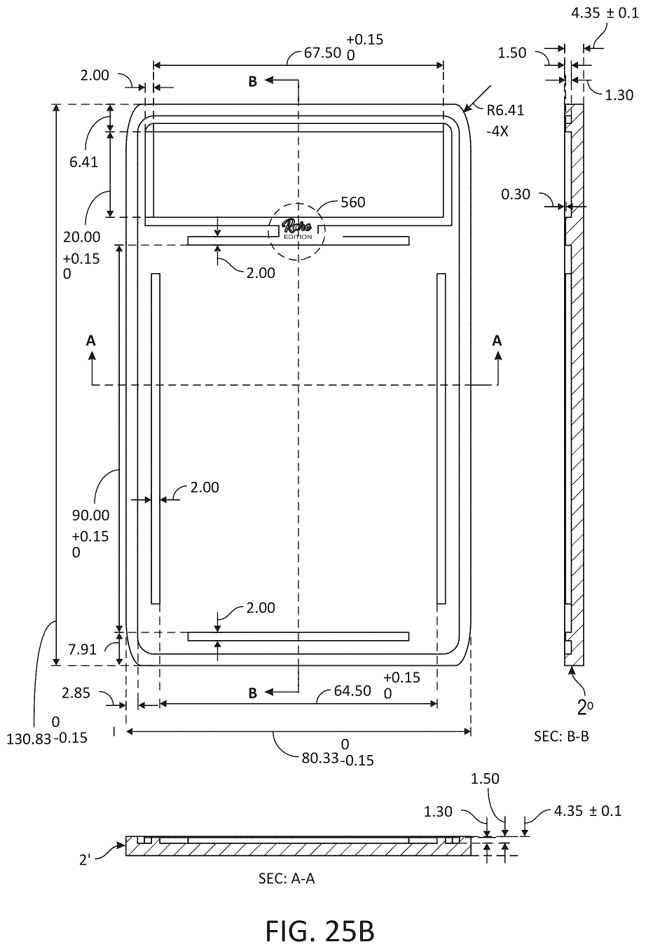

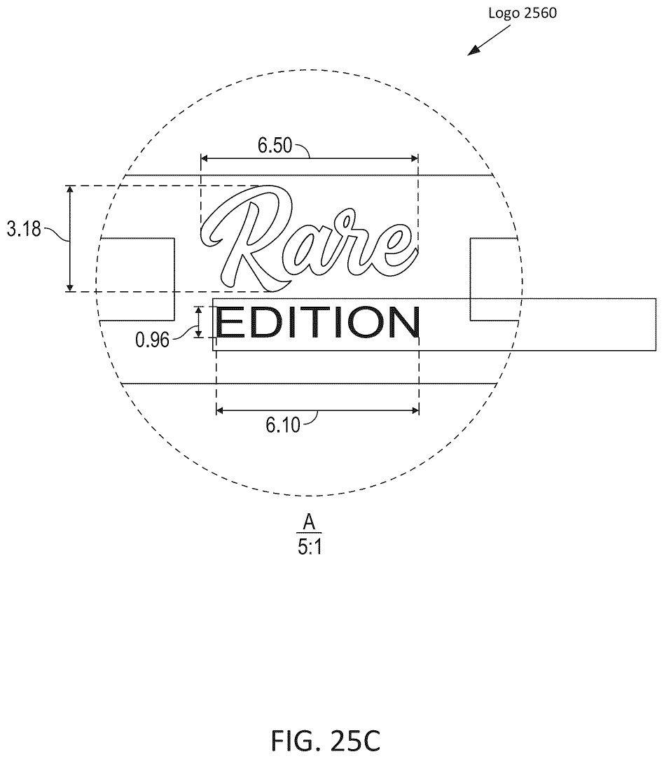

In some embodiments, multiple supporting members 2130 and 2135 are arranged on one side of the rear panel 2100 to create a lower window portion 2142 as depicted in FIG. 21A. When the rear panel 2100 is coupled to a front panel, the lower window portion 2142 created by the multiple supporting members 2130 defines the lower portion 110 of FIG. 1A. The placement of the multiple supporting members 2130 may be configured to accommodate collectible cards, trading cards, and game cards of different sizes. The multiple supporting members 2130 and 2135 may be composed of polycarbonate. As seen in FIG. 25B, the card protector can accept a card with a length of approximately 90 mm and a width of approximately 64.5 mm. In some embodiments, the multiple protrusions of the lower portion wall have a width of approximately 2 mm. In some embodiments, the protective apparatus is an archival-safe product.

In some embodiments, the supporting member 2135 may define the upper window portion 2145 as well as an upper limit of the lower window portion 2142. The supporting member 2135 may have a shape that is different from that of the multiple supporting members 2130. In some embodiments, the supporting member 2135 may also create an upper window portion 2145. In the illustrated embodiment, the supporting member 2135 is fabricated and arranged on the front side of the rear panel 2100 to generate an enclosed perimeter of the upper window portion 2145. In one example, multiple supporting members are fabricated and arranged to generate a perimeter of the upper window portion 2145. More details regarding the measurements of the various components of the rear panel 2100 will be discussed in FIG. 25A.

In some embodiments, a logo may be placed on the supporting member 2135 in the area between the lower window portion 2142 and upper window portion 2145. The logo may be embossed into the supporting member 2135. In various embodiments, a hot stamping method may be used to give the logo color. Hot stamping may be necessary to make an impression on polycarbonate.

FIG. 22A depicts a back side 2210 of a front panel 2200 that makes up the collectible-protective apparatus 100 in some embodiments. The front panel 2200 may be completely or a portion may be transparent. In various embodiments, mask 2260 is an opaque material (e.g., tape, paper, or the like) adhered or otherwise coupled to the inside (e.g., back side 2210) of the front panel 2200. The mask 2260 may be positioned along the perimeter of the back side 2210 of the front panel 2200. The mask 2260 may form windows (e.g., an upper window and a lower window) in the front panel 2200 thereby allowing the collectible object to be viewed through the lower window. The lower window may be the size of the collectible object (e.g., the lower window may be the length and width of a collectible card). The upper window may be the same width as the lower window. The upper window may be shorter than the lower window. The upper window may display media (e.g., paper, plastic, logo, hologram, information, and the like). It may be appreciated that the mask 2260 may define any number of windows of any size or shape.

When the front panel 2200 is coupled with the rear panel 2100, the mask 2260 will be within the collectible-protective apparatus 100.

It may be appreciated that the mask 2260 may be optional. In various embodiments, the front panel 2200 may be a combination of materials such as a transparent window (e.g., the upper window and the lower window) surrounded by opaque or semi-transparent materials.

Similar to the rear panel 2100 of FIG. 21A, the front panel 2200 may include an elevated edge 2220 that is fabricated and arranged along the perimeter of a body of the front panel 2200. The elevated edge 2220 may be coupled with the rear panel 2100 and/or the perimeter member 2120 to hold the rear panel 2100 and the front panel 2200 together. For example, the top of the elevated edge 2220 and or a side of the elevated edge 2220 may be melted or fused with the rear panel 2100 and/or the perimeter member 2120, thereby securing the collectible object, preventing debris from entering into the collectible-protective apparatus 100, and/or preventing tampering.

The front panel 2200 may be in a rectangular shape. In various embodiments, the back side 2210 has a width and length that is the same or substantially the same as the width and length of the rear panel 2100 of FIG. 21A. In some embodiments, the front panel 2200 is composed of polycarbonate. In various embodiments, the elevated edge 2220 is a single-piece polycarbonate. In one example, the elevated edge 2220 includes multiple pieces of polycarbonate adhered together.

In one example, the front panel may have a length and width that is greater than that of the rear panel 2100, such that the rear panel 2100 may be placed in an opening of the front panel before the protective apparatus is coupled together using an ultrasonic welder or laser welding. An example of this configuration of the rear panel 2100 and front panel 2200 may be seen in FIG. 9 which depicts a cross section of the panels of the protective apparatus. In some embodiments, a cavity of the front panel 2200 created by the elevated edge 2220 may have a width 2230 that is the same or substantially the same as the width 2105 of the rear panel 2100.

FIG. 22B depicts a front side 2250 of the front panel 2200 that makes up the collectible-protective apparatus 100 in some embodiments. In some embodiments, the front panel 2200 may be transparent or semi-transparent. In various embodiments, a scratch-resistant glass, such as CORNING® GORILLA® glass, may be applied to the front side 2250 of the front panel 2200. The front panel 2200 and the rear panel 2100 of FIG. 21A may be assembled into a card protector, such as a collectible-protective apparatus 2400 of FIG. 24A.

The front panel 2200 may include transparent windows for the upper portion and the lower portion discussed herein. In various embodiments, the front panel 2200 is predominantly transparent (e.g., except for the elevated edge 2220) and a mask (e.g., mask 150) may cover all or part of the front side 2250 of the front panel 2200 to form any number of windows.

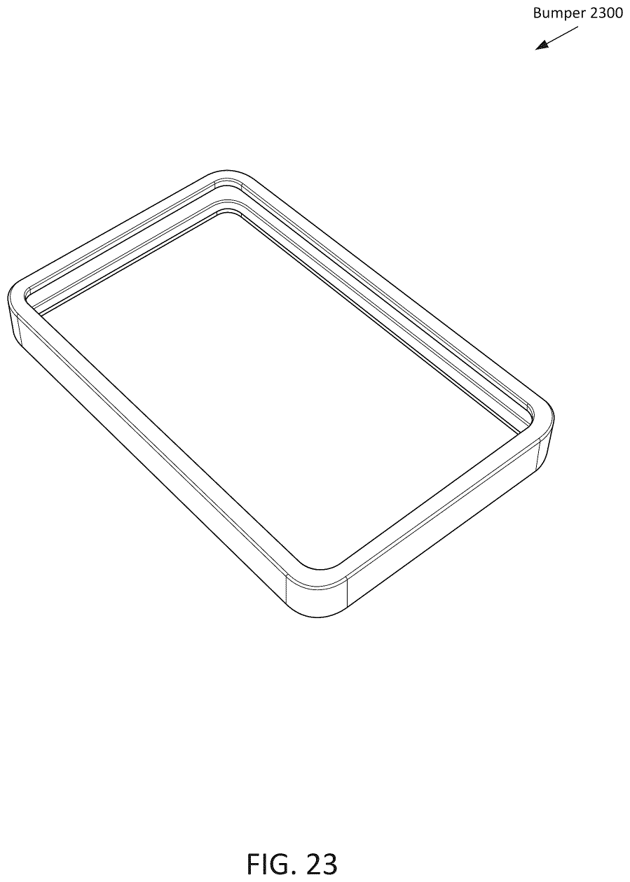

FIG. 23 depicts a perspective view of a bumper 2300 according to some embodiments. The bumper 2300 may be composed of any resilient material such as silicone, thermoplastic elastomers (TPEs), latex, or rubber.

In some embodiments, the bumper 2300 consists of a single piece of silicon fabricated into a shape that allows the bumper 2300 to surround or protect the protective apparatus. In one example, the bumper 2300 may be placed around the outer perimeter of the collectible-protective apparatus 100 of FIG. 1A. In various embodiments, the bumper 2300 is removable and provides further protection to the card protector by protecting the card protector from the impact of falls or bumps.

The bumper 2300 may be removable. In some embodiments, the bumper 2300 is adhered or fastened to the collectible-protective apparatus 100 as a further security feature to avoid tampering.

FIG. 24A depicts a front view of another collectible-protective apparatus 2400 with a bumper in some embodiments. The collectible-protective apparatus 2400 includes a bumper 2420. The collectible-protective apparatus 2400 may be similar to the collectible-protective apparatus 100 of FIG. 1A. A view 2460 of FIG. 24B shows the collectible-protective apparatus 2400 from another perspective.

The collectible-protective apparatus 2400 includes a mask 2440. The mask 2440 may adhere to the top of the collectible-protective apparatus 2400 or from within inside the front panel of the collectible-protective apparatus 2400. The mask 2440 may include an opaque material coupled to the front panel of the collectible-protective apparatus 2400 to create a lower portion window 2450 and an upper portion window 2455. Alternately, there may be a lower portion window 2450 and an upper portion window 2455 defined by the front panel (e.g., there may be two transparent windows retained or within the front panel of the collectible-protective apparatus 2400) and the mask 2440 is ornamental and/or may cover security features discussed herein.

In some embodiments, the mask 2440 may be black in color. In some embodiments, the mask may be applied to one side of the top portion of the protective apparatus using a hot stamping method. It will be appreciated that other printing methods may be utilized to apply the mask to the top portion of the protective apparatus.

In some embodiments, the mask 2440 may hide the appearance of the supporting members, such as the supporting members 2130 and 2135 of FIG. 21A. In various embodiments, a logo (e.g., “Rare Edition”) may be placed in or on an area of the mask 2440 between the lower portion window 2450 and the upper portion window 2455. In one embodiment, NFC chip and/or RFID tags may be placed in the collectible-protective apparatus 2400 as an added authentication or certification feature. The NFC chip and/or RFID tag may be hidden by the mask 2440. In some embodiments, the NFC chip and/or RFID tag may be within the collectible-protective apparatus 2400.

In some embodiments, the user may interact with the RFID tag or NFC chip using a mobile computing device with a software application installed thereon. The user may bring a mobile computing device, such as a smartphone, in proximity to the collectible-protective apparatus 2400. When a user interacts with the RFID tag or NFC chip, the user may be provided with an address or be directed to navigate to a webpage containing information regarding the card and/or rating system.

In some embodiments, the webpage or card information may include digital images or videos of the collectible card. The webpage or card information may include details of the physical condition of the collectible card and grading information such as overall features that impact value (e.g., rareness of the card, features that were used to grade the card), quality of the card, and/or any damage that may impact grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

In some embodiments, the collectible-protective apparatus 2400 is transparent or semi-transparent. In some embodiments, the front side of the top portion of the protective apparatus has a matte or glossy surface.

The bumper 2420 may be removable to provide further protection to the card protector by protecting it from the impact of falls or drops. In one embodiment, the removable bumper is available in different colors, allowing a user to customize or organize card protectors using different colored bumpers. In various embodiments, the removable bumper is fabricated with other materials such as thermoplastic elastomers (TPEs), latex, or rubber. A logo, such as logo 2470, as seen in FIG. 24B may be fabricated on the top of bumper 2420. In some embodiments, a logo 2472 may be fabricated on the bottom of the bumper, as seen in FIG. 24C.

FIG. 25A depicts back panel 2500 and cross-sections of the back panel in some embodiments. For simplicity, measurements of various components of back panel 2500 can be found in FIG. 25B. In the illustrated embodiment of FIG. 25B, measurements of various aspects of the card protector are shown, such as the length of 90 mm and width of 64.5 mm of the lower window portion. A fabrication tolerance for one or more of the components may also be found in FIG. 25B, for example, The width of the back panel 2500 may be 80.33 mm. It can be appreciated that the measurements of the card protector may be different.

The back panel 2500 includes a body 2510 with an elevated ledge 2520. The body 2510 may be a horizontal sheet of polycarbonate in a rectangular shape and may have rounded or sharp corners. In various embodiments, the body 2510 is a quadrilateral and may have rounded or sharp corners. The body 2510 may be composed of polycarbonate or polystyrene. In some embodiments, the body 2510 may have a height of 2.85 mm, a length of 130.83 mm, and a width of 80.33 mm.

The elevated ledge 2520 runs along the perimeter of the body 2510. In one embodiment, the elevated ledge 2520 has a width of 2.85 mm and a height of 1.5 mm from the surface of the body 2510. The elevated ledge 2520 may provide further protection from water and dust from getting into the lower window portion and the card placed therein.

The back panel 2500 further includes supporting members 2530 and 2532 that are fabricated and arranged on a front side of the back panel 2500 to create a lower window portion 2540. In some embodiments, the supporting members 2530 and 2532 may have a width of 2.00 mm. When the back panel 2500 is coupled to a front panel, the lower window portion 2540 created by the supporting members 2530 and 2532 defines the lower portion 110 of FIG. 1A. In some embodiments, the perimeter of the lower window portion 2540 may be fabricated from a single supporting member similar to the enclosed perimeter of the upper window portion 2545.

The placement of the supporting members 2530, 2532, and 2536 may be configured to accommodate collectible cards, trading cards, and game cards of different sizes.

The supporting members 2530, 2532, and 2536 may be composed of polycarbonate or TPU (thermoplastic polyurethane). In one example, the supporting members 2530, 2532, and 2536 may be composed of TPU while the protector apparatus 100 may be composed of polycarbonate. The supporting members 2530, 2532, and 2536 may be composed of TPU to hold but not damage the card/collectible. Further, the TPU of the supporting members 2530, 2532, and 2536 may also lessen the chance of a card/collectible getting damaged from shaking. As seen in FIG. 25A, the card protector can accept a card with a length of approximately 90 mm and a width of approximately 64.5 mm.

In some embodiments, a supporting member 2534 defines the upper window portion 2545 as well as an upper limit of the lower window portion 2540. The supporting member 2534 may have a shape that is different from that of the supporting member 2532. In some embodiments, the supporting member 2534 may include a protrusion that has the same dimensions as the supporting member 2532 as well as defining an enclosed perimeter of the upper window portion 2545. In some embodiments, the supporting member 2534 has a width of 2.00 mm and a height of 1.3 mm. In one example, the upper window portion 2545 has a width of 67.5 mm and a length of 20 mm.

Similar to the supporting members 2530, 2532, and 2536, supporting member 2534 may be composed of any resilient material. For example, the supporting member 2534 may be composed of polycarbonate or TPU. In one example, the supporting members 2530, 2532, 2534, and 2536 may be composed of TPU while the protector apparatus 100 may be composed of polycarbonate. It will be appreciated that in some embodiments, the different supporting members 2530, 2532, 2534, and 2536 may be composed of different materials (or different combination of materials).

In various embodiments, a logo (e.g., “Rare Edition”) 2560 may be stamped or molded into the supporting member 2534. The logo 2560 has a height/depth of 0.3 mm. Further details regarding the logo may be discussed in FIG. 25C.

The upper window portion 2545 may support a grading card. The grading card may be a certificate indicating a score or category of the card based on the properties of the card. Properties may include, for example, centering of images on the card, sharpness of the corners of the card, gloss on the card, fading of pictures, degradations of card stock quality, and the presence of any imperfections. In one embodiment, properties of the collectible card include the availability of a particular collectible card, and flaws to the collectible card. In some embodiments, a third-party grading system may certify and authenticate a card and provide grading to the card according to specifications of the third-party grading system.

The grading card may include security or authenticity features such as holograms or security ink. In some embodiments, the grading card may include a quick response (QR) code, bar code, RFID tag, or NFC chip may be integrated into the grading card or the upper window portion 2545. A user may interact with the QR code, bar code, RFID tag, or NFC chip using a mobile device with a software application installed thereon. The user may bring a mobile computing device, such as a smartphone, in proximity to the grading card, an address, or a webpage may be provided to the user's smartphone. The address or webpage may contain information regarding the card and/or grade or rating associated with the card. In some embodiments, the information may include digital images or video of the card showing different aspects of the card, close-up images of any imperfections may be imaged or highlighted. In various embodiments, the information may include a write-up by the person who graded the card with insight or opinion on the grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

Cross-section A-A and B-B are also depicted in FIG. 25A, with lines A-A and B-B indicating the location of the cross-section.

In the illustrated embodiment of FIG. 25B, measurements of various aspects of the card protector are shown, such as the length of 90 mm and width of 64.5 mm of the lower window portion. It can be appreciated that the measurements of the card protector may be different.

FIG. 25C depicts measurements of logo 2560 in some embodiments. In some embodiments, the logo 2560 includes two words, “Rare” and “EDITION.” In one embodiment, the word “Rare” may have a width of 6.5 mm and a height of 3.18 mm, while “EDITION” may have a width of 6.1 mm and a height of 0.96 mm. In one embodiment, the logo 2560 may be embossed or stamped into the supporting member 2534 of the back panel 2500. In some embodiments, other methods may be used to transfer the logo onto the supporting member 2534. In one example, the logo 2560 may be gold in color, the color of the logo 2560 may be hot stamped. In some embodiments, other printing methods may be used to give the logo color.

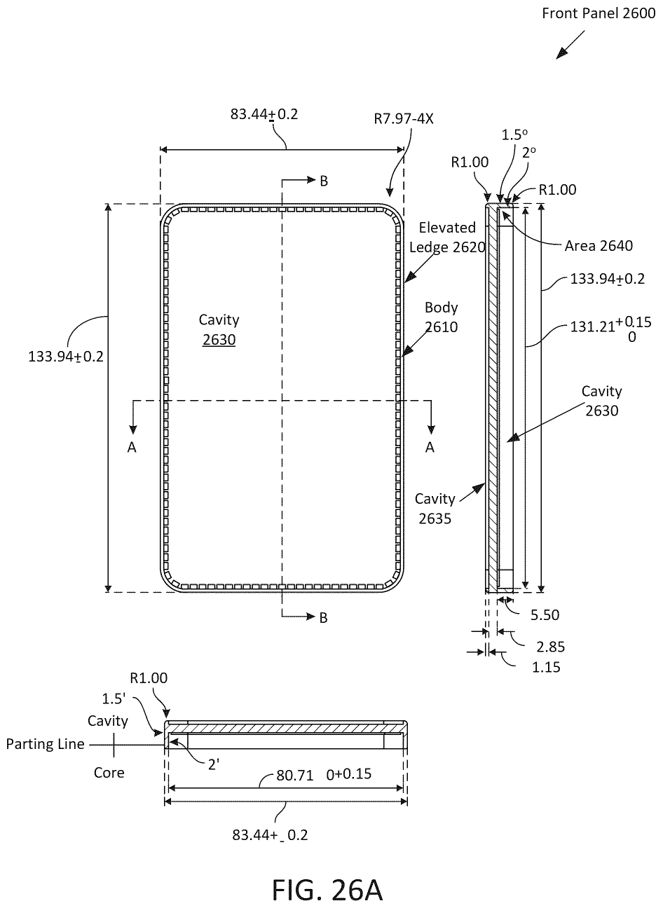

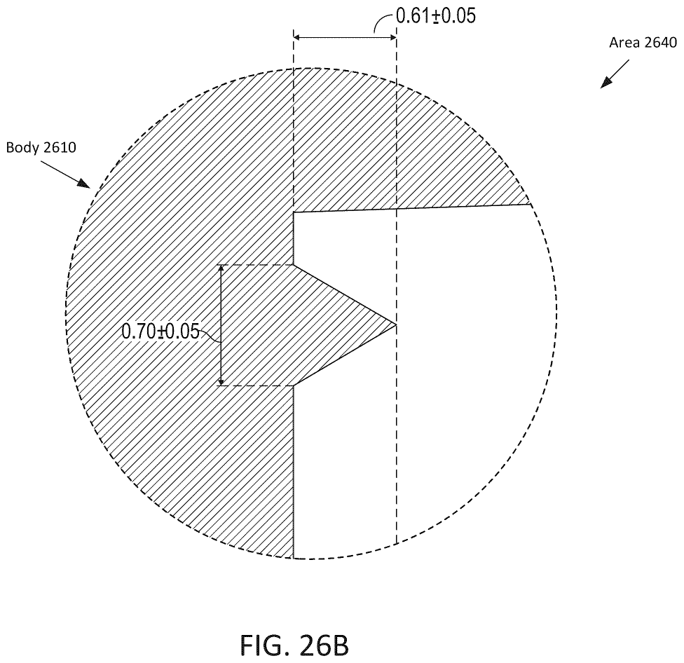

FIG. 26A depicts front panel 2600 and cross-sections of the card protector in some embodiments. In the illustrated embodiment of FIG. 26A, measurements of various aspects of the card protector are shown, such as a length of 133.94 mm and a width of 83.44 mm of the front panel 2600.

The front panel 2600 includes a body 2610 with an elevated ledge 2620. The body 2610 may be a horizontal sheet of polycarbonate in a rectangular shape and may have rounded or sharp corners. The front panel 2600 may have the same shape as the back panel 2500. The front panel 2600 may be composed of polycarbonate or polystyrene. In some embodiments, the body 2610 may have a height of 2.85 mm, a length of 133.94 mm, and a width of 83.44 mm. In the illustrated embodiment of FIGS. 26A and 25A, the front panel 2600 is physically larger than the back panel 2500. Furthermore, front panel 2600 may include two cavities, one on a front side and one on the back side. During the fabrication of the protective apparatus, back panel 2500 may be placed inside a cavity 2630 on the back side of the front panel 2600. In some embodiments, the cavity 2630 may have a length of 131.21 mm, a width of 80.71 mm, and a height of 5.50 mm. A scratch-resistant glass, such as CORNING® GORILLA® glass, may be applied to a cavity 2635 on the front side of the front panel 2600. The cavity 2635 may be fabricated or located on a surface of the front panel 2600 that is opposite from the cavity 2630. In some embodiments, the cavity 2635 may have a height of 1.15 mm. The front panel 2600 further includes an area 2640. The area 2640 may be a protrusion of the body 2610. In some embodiments, this protrusion may be utilized as an energy director for ultrasonic welding. Further details regarding the protrusion seen in area 2640 will be discussed in FIG. 26B.

The area 2640 from FIG. 26B is an energy director for ultrasonic welding in some embodiments. In the illustrated embodiment, area 2640 is a triangular protrusion from the body 2610. The triangular protrusion may have a base of 0.70 mm and a height of 0.61 mm. It can be appreciated that the measurements of the card protector may be different. The energy director focuses the ultrasonic energy at an apex of the energy director, causing the material which makes up the triangular protrusion to melt and flow, thereby forming a weld.

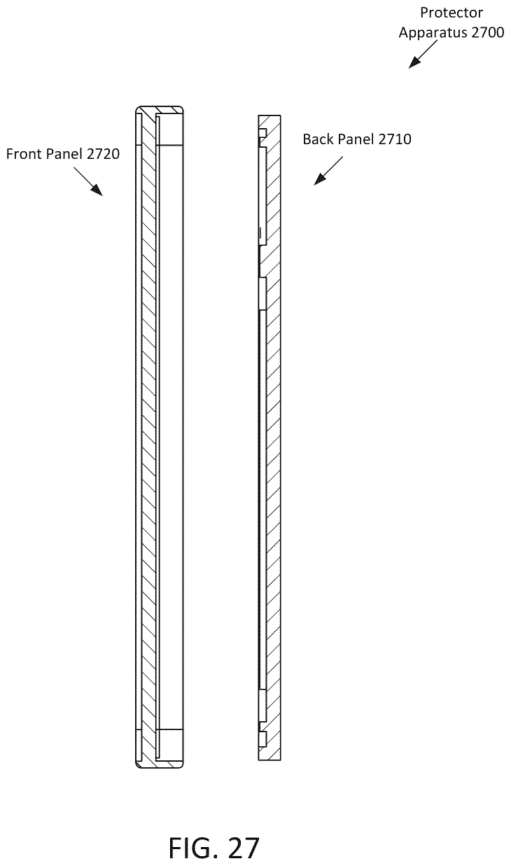

FIG. 27 depicts a cross-section of a back panel 2710 and a front panel 2720 of protective apparatus 2700 in some embodiments. After the back panel 2710 and the front panel 2720 have been fabricated, the two panels may be assembled to fabricate the card protective apparatus. In some embodiments, the back panel 2710 and the front panel 2720 may be adhered together using ultrasonic welding. As seen in FIGS. 25B and 27, the back panel 2710 includes a surface area that is smaller than a cavity of the front panel 2720 such that the back panel 2710 may be contained within the cavity of the front panel 2720. By retaining the back panel 2710 within the confines of front panel 2720, the protective apparatus 2700 may become more tamper-proof, making it more difficult to separate the back panel 2710 from the front panel 2720.

In various embodiments, a grading card system and marketplace may allow for grading and trading of collectible objects protected by the collectible-protective apparatus 100. The collectible-protective apparatus 100 may include link information (e.g., URL), unique code (e.g., passcode, barcode, or QR code), and the like that identifies the collectible and/or links to the grading system and/or the marketplace for the collectible object.

In some embodiments, the unique code may include an encryption code or other security code such that, using the collectible-protective apparatus 100 (or information contained within), the user may access a secure, online location to update information about the collectible object. For example, the user may scan a QR code on the collectible-protective apparatus 100 using their smartphone or an app that navigates a browser or the app to a secure location of the grading system or the marketplace system. The secure location may allow the user to update information about the collectible object, including ownership information, contact information, information about the quality of the collectible object, and/or the like. The changes in the information of the collectible object may be displayed within the grading system or the marketplace.

FIG. 30 is a block diagram illustrating entities of an example digital device able to read instructions from a machine-readable medium and execute those instructions in a processor to provide control functions, provide interfaces, receive commands, and the like as discussed herein. Specifically, FIG. 30 shows a diagrammatic representation of a digital device in the example form of a digital device 3000 within which instructions 3018 (e.g., software) for causing the machine to perform any one or more of the methodologies discussed herein may be executed. In alternative embodiments, the machine operates as a standalone device or may be connected (e.g., networked) to other machines, for instance, via the Internet.

The digital device may include a processor and memory any may include a PIC, processor, raspberry PI, or the like.

The example digital device 3000 includes a processor 3002 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 3004, and a static memory 3006, which are configured to communicate with each other via a bus 3008. The digital device 3000 may further include a graphics display unit 3010 (e.g., a plasma display panel (PDP), a liquid crystal display (LCD), a projector, or a cathode ray tube (CRT)). The digital device 3000 may also include a data store 3012 and a network interface device 3014, which also are configured to communicate via the bus 3008.

The data store 3012 includes a machine-readable medium 3016 on which is stored instructions 3018 (e.g., software) embodying any one or more of the methodologies or functions described herein. The instructions 3018 (e.g., software) may also reside, completely or at least partially, within the main memory 3004 or within the processor 3002 (e.g., within a processor's cache memory) during execution thereof by the digital device 3000, the main memory 3004 and the processor 3002 also constituting machine-readable media. The instructions 3018 (e.g., software) may be transmitted or received over a network (not shown) via optional network interface 3014.

While machine-readable medium 3016 is shown in an example embodiment to be a single medium, the term “machine-readable medium” should be taken to include a single medium or multiple media (e.g., a centralized or distributed database, or associated caches and servers) able to store instructions (e.g., instructions 3018). The term “machine-readable medium” shall also be taken to include any medium that is capable of storing instructions (e.g., instructions 3018) for execution by the digital device and that cause the machine to perform any one or more of the methodologies disclosed herein. The term “machine-readable medium” includes, but should not be limited to, data repositories in the form of solid-state memories, optical media, and magnetic media.

1. A method comprising:
receiving, from a first user, account identification information associated with the first user;
authenticating, by a collectible object management system, the first user based on the received account identification information associated with the first user;
receiving, from the first user, a first collectible protective apparatus identifier and a first collectible object identifier, the first collectible protective apparatus identifier being associated with a first collectible protective apparatus, the first collectible object identifier being associated with a first collectible object protected by the first collectible protective apparatus;
authenticating, by the collectible object management system, the first collectible protective apparatus identifier and the first collectible object identifier;
providing, by the collectible object management system, a user interface associated with the first collectible object;
receiving a request to upload a first digital media to the collectible management system, the digital media being associated with the first collectible object; and
storing the first digital media to the collectible management system.

2. The method of claim 1, wherein the first collectible object is stored within the first collectible protective apparatus.

3. The method of claim 1, wherein the first collectible protective apparatus comprises:
a first panel, the first panel including a front side and a back side, the first panel including at least a transparent portion; and
a rear panel coupled to the first panel, the rear panel including a front side and a back side, the front side of the rear panel including at least four supporting members, each of the at least four supporting members including a flat edge to enable positioning of the collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object.

4. The method of claim 1, wherein the collectible object identifier is located on a grading certificate.

5. The method of claim 4, wherein the grading certificate is located in an upper portion of the collectible protective apparatus.

6. The method of claim 1, wherein the first collectible protective apparatus identifier is located on a bottom edge of the first collectible protective apparatus.

7. The method of claim 6, wherein the first collectible protective apparatus identifier is a numerical identifier.

8. The method of claim 6, wherein the first collectible protective apparatus identifier is a bar code.

9. The method of claim 3, wherein the collectible protective apparatus further comprises: a security feature between the first panel and the second panel, the security feature including at least one of an NFC chip and an RFID chip, the security feature being beneath a mask such that the security feature is not visible from the front of the first panel, wherein the NFC chip or the RFID chip provide the first collectible protective apparatus identifier.

10. The method of claim 1 further comprising:
receiving, from a second user, account identification information associated with the second user;
authenticating, by a collectible object management system, the second user based on the received account identification information associated with the second user;
receiving, from the second user, a second collectible protective apparatus identifier and a second collectible object identifier, the second collectible protective apparatus identifier being associated with a second collectible protective apparatus, the first collectible object identifier being associated with a first collectible object protected by the first collectible protective apparatus;
providing, by the collectible object management system, a user interface associated with the second collectible object;
receiving a request to upload a second digital media to the collectible management system, the digital media being associated with the second collectible object; and
storing the second digital media to the collectible management system.

11. The method of claim 1, further comprising, receiving, from a third user, a request to view the first digital media associated with the first collectible object and providing to the third user access to view the first digital media, the third user not having access to change the first digital media without the first collectible protective apparatus identifier and the first collectible object identifier.

12. A system comprising:
a first collectible protective apparatus, the first collectible protective apparatus including a first collectible object identifier;
a first collectible object, the first collectible object being stored within the first collectible protective apparatus, the first collectible object including a first collectible protective apparatus identifier;
a collectible object management system;
at least one processor;
a memory including instructions to configure the at least one processor to instruct the collectible object management system perform a method, the method comprising:
receiving the first collectible protective apparatus identifier and the first collectible object identifier being associated with a first collectible object;
providing a user interface associated with the first collectible object;
receiving a request to upload a first digital media to the collectible management system, the digital media being associated with the first collectible object; and
storing the first digital media to the collectible management system.

13. The system of claim 12, wherein the collectible object is stored within the collectible protective apparatus.

14. The system of claim 12, wherein the first collectible protective apparatus further includes:
a first panel, the first panel including a front side and a back side, the first panel including at least a transparent portion; and
a rear panel coupled to the first panel, the rear panel including a front side and a back side, the front side of the rear panel including at least four supporting members, each of the at least four supporting members including a flat edge to enable positioning of the collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object.

15. The system of claim 12, wherein the collectible object identifier is located on a grading certificate.

16. The system of claim 15, wherein the grading certificate is located in an upper portion of the collectible protective apparatus.

17. The system of claim 12, wherein the first collectible protective apparatus identifier is located on a bottom edge of the first collectible protective apparatus.

18. The system of claim 14, wherein the collectible protective apparatus further comprises: a security feature between the first panel and the second panel, the security feature including at least one of an NFC chip and an RFID chip, the security feature being beneath a mask such that the security feature is not visible from the front of the first panel, wherein the NFC chip or the RFID chip provide the first collectible protective apparatus identifier.

19. The system of claim 12 wherein the method further comprise:
receiving, from a second user, account identification information associated with the second user;
authenticating, by a collectible object management system, the second user based on the received account identification information associated with the second user;
receiving, from the second user, a second collectible protective apparatus identifier and a second collectible object identifier, the second collectible protective apparatus identifier being associated with a second collectible protective apparatus, the first collectible object identifier being associated with a first collectible object protected by the first collectible protective apparatus;
providing, by the collectible object management system, a user interface associated with the second collectible object;
receiving a request to upload a second digital media to the collectible management system, the digital media being associated with the second collectible object; and
storing the second digital media to the collectible management system.

20. The system of claim 12 wherein the collectible object management system is further configured to receive, from a third user, a request to view the first digital media associated with the first collectible object and provide to the third user access to view the first digital media, the third user not having access to change the first digital media without the first collectible protective apparatus identifier and the first collectible object identifier.

21. A non-transitory computer readable medium comprising instructions executable by one or more processors to perform a method, the method comprising:
receiving, from a first user, account identification information associated with the first user;
authenticating, by a collectible object management system, the first user based on the received account identification information associated with the first user;
receiving, from the first user, a first collectible protective apparatus identifier and a first collectible object identifier, the first collectible protective apparatus identifier being associated with a first collectible protective apparatus, the first collectible object identifier being associated with a first collectible object protected by the first collectible protective apparatus;
authenticating, by the collectible object management system, the first collectible protective apparatus identifier and the first collectible object identifier;
providing, by the collectible object management system, a user interface associated with the first collectible object;
receiving a request to upload a first digital media to the collectible management system, the digital media being associated with the first collectible object; and
storing the first digital media to the collectible management system.
